(19) United States
(12) Patent Application Publication
(10) Pub. No.: US 2026/0264408 A1
(43) Pub. Date: Sep. 10, 2026

(54) PRINTER AND MAINTENANCE METHOD OF INK ABSORBING ROLLER

(71) Applicant: SCREEN Holdings Co., Ltd., Kyoto (JP)

(72) Inventors: Kaisei KAJIHARA, Kyoto-shi (JP); Yusei TANAKA, Kyoto-shi (JP)

(21) Appl. No.: 19/560,286

(22) Filed: Mar. 9, 2026

(30) Foreign Application Priority Data
Mar. 10, 2025 (JP) 2025-037243
Aug. 19, 2025 (JP) 2025-136265

(51) Int. Cl. B41J 2/165; B08B 1/14; B08B 1/52; B41J 2/17; B41J 29/17

(52) U.S. Cl. CPC B41J 2/16541; B08B 1/14; B08B 1/52; B41J 2/16544; B41J 2/1742; B41J 29/17

(57) ABSTRACT

The surface layer 811 of the cleaning roller 81 (ink absorbing roller) for absorbing ink from the wiper blade 59 (wiper) is rotatable about the rotation axis 813. Then, by moving the squeezing block 44 (squeezing member) in the X direction (moving direction) relative to the surface layer 811 of the cleaning roller 81 while bringing the squeezing block 44 into contact with the surface layer 811 of the cleaning roller 81, ink is squeezed from the surface layer 811 of the cleaning roller 81 by the squeezing block 44. The X direction is orthogonal to the rotation axis 813 (in other words, the width direction Dy in which the rotation axis 813 is extended) and the surface layer 811 of the cleaning roller 81 rotates, following the squeezing block 44 which relatively moves in the X direction.

### CROSS REFERENCE TO RELATED APPLICATION

The disclosure of Japanese Patent Application No. 2025-136265 filed on Aug. 19, 2025 and No. 2025-037243 filed on Mar. 10, 2025 including specification, drawings and claims is incorporated herein by reference in its entirety.

### BACKGROUND

### 1. Field of the Disclosure

This disclosure relates to a maintenance technique of an ink absorbing roller for absorbing ink from a wiper which wipes off the ink from a nozzle opening plane of an inkjet head.

### 2. Description of the related art

Conventionally, an inkjet printer which ejects ink from a nozzle which opens in a nozzle opening plane of an inkjet head has been well known. In such a printer, the nozzle opening plane is contaminated with ink adhering to the nozzle opening plane. For this reason, a wiper for wiping off ink from the nozzle opening plane is used. Further, in Japanese Patent Application Laid Open Gazette No. 2022-148370 and Japanese Patent Application Laid Open Gazette No. 03-240554, an absorbing member (wiping member, ink absorber) wipes off ink from the wiper, to thereby keep the wiper clean. Furthermore, provided is a squeezing member (pressing member, squeezing member) for squeezing ink accumulated in the absorbing member from the absorbing member. Specifically, by pressing the squeezing member to the absorbing member, ink is squeezed from the squeezing member.

### SUMMARY

In a case where pressing of the squeezing member to the absorbing member is repeated in order to squeeze ink, however, the absorbing member is sometimes worn out. With such a worn-out absorbing member, it becomes hard to sufficiently wipe off ink from the wiper.

This disclosure is intended to solve the above-described problem, and it is an object of this disclosure to make it possible to squeeze ink from an ink absorbing roller which absorbs ink from a wiper while suppressing the ink absorbing roller from being worn out.

A printer according to the disclosure comprises: an inkjet head having a nozzle opening plane having an opening from which ink is ejected; a wiper contacting the nozzle opening plane of the inkjet head to wipe off ink from the nozzle opening plane; an ink absorbing roller rotatably supported about a predetermined rotation axis; a squeezing member; and a moving mechanism configured to move the squeezing member relative to the ink absorbing roller in a moving direction orthogonal to the rotation axis, wherein the ink absorbing roller contacts the wiper to absorb ink from the wiper, to thereby clean the wiper, the moving mechanism moves the squeezing member relative to the ink absorbing roller in the moving direction while the squeezing member is in contact with the ink absorbing roller, to thereby causes the squeezing member to squeeze ink from the ink absorbing roller, and the ink absorbing roller rotates, following the squeezing member which moves relatively in the moving direction.

A maintenance method of an ink absorbing roller which absorbs ink from a wiper wiping off ink from a nozzle opening plane of an inkjet head according to the disclosure comprises: squeezing ink from the ink absorbing roller by a squeezing member, by moving the squeezing member relatively to the ink absorbing roller in a moving direction while the squeezing member is in contact with the ink absorbing roller, wherein the ink absorbing roller rotates, following the squeezing member which moves relatively in the moving direction.

In the present disclosure (the printer and the maintenance method of the ink absorbing roller) having such a configuration, the ink absorbing roller for absorbing ink from the wiper is configured to rotate about the rotation axis. Then, ink is squeezed from the ink absorbing roller by the squeezing member, by moving the squeezing member relative to the ink absorbing roller in the moving direction while bringing the squeezing member into contact with the ink absorbing roller. At that time, the moving direction is orthogonal to the rotation axis, and the ink absorbing roller rotates, following the squeezing member which moves relatively in the moving direction. Therefore, it is possible to suppress an excessive force from being imposed on the ink absorbing roller by rotating the ink absorbing roller. As a result, it becomes possible to squeeze ink from the ink absorbing roller while suppressing wear of the ink absorbing roller which absorbs ink from the wiper.

### BRIEF DESCRIPTION OF THE DRAWINGS

FIG. 1 is an elevational view schematically showing one example of a printer in accordance with the present disclosure;

FIG. 2A is a schematic view showing a positional relationship among a print head in a head unit, a maintenance part, and a web;

FIG. 2B is a schematic view showing a positional relationship among the print head in the head unit, the maintenance part, and the web;

FIG. 2C is a schematic view showing a positional relationship among the print head in the head unit, the maintenance part, and the web;

FIG. 3 is a bottom view schematically showing a configuration of the print head;

FIG. 4 is a perspective view schematically showing a configuration of the maintenance part;

FIG. 5A is a perspective view showing an appearance of the head unit 3;

FIG. 5B is an external perspective view showing a frame 70 in the head unit 3;

FIG. 6 is a side elevational view showing the head unit 3;

FIG. 7A is a side elevational view showing an operation of the head unit 3;

FIG. 7B is a side elevational view showing the operation of the head unit 3;

FIG. 7C is a side elevational view showing the operation of the head unit 3;

FIG. 8A is a perspective view schematically showing a configuration of the maintenance part and a cleaning part;

FIG. 8B is a plan view schematically showing the configuration of the maintenance part and the cleaning part;

FIG. 9A is a partial side elevational view schematically showing an ink collection unit included in the printer shown in FIG. 1;

FIG. 9B is a partial perspective view schematically showing the ink collection unit included in the printer shown in FIG. 1;

FIG. 9C is a partial cross-sectional view schematically showing the ink collection unit included in the printer shown in FIG. 1;

FIG. 9D is a perspective view schematically showing a squeezing block included in the ink collection unit shown in FIGS. 9A-9C;

FIG. 10A is a view schematically showing an operation of the maintenance part and the cleaning part;

FIG. 10B is a view schematically showing the operation of the maintenance part and the cleaning part;

FIG. 10C is a view schematically showing the operation of the maintenance part and the cleaning part;

FIG. 10D is a view schematically showing the operation of the maintenance part and the cleaning part;

FIG. 10E is a view schematically showing the operation of the maintenance part and the cleaning part;

FIG. 10F is a view schematically showing the operation of the maintenance part and the cleaning part;

FIG. 11A is a view showing a variation of the cleaning part;

FIG. 11B is a view showing a variation of the cleaning part;

FIG. 11C is a view showing a variation of the cleaning part;

FIG. 11D is a view showing a variation of the cleaning part;

FIG. 12 is a view schematically showing an operation of the maintenance part and the cleaning part;

FIG. 13 is a view schematically showing the operation of the maintenance part and the cleaning part; and

FIG. 14 is a view schematically showing the operation of the maintenance part and the cleaning part.

### DETAILED DESCRIPTION OF THE PREFERRED EMBODIMENTS

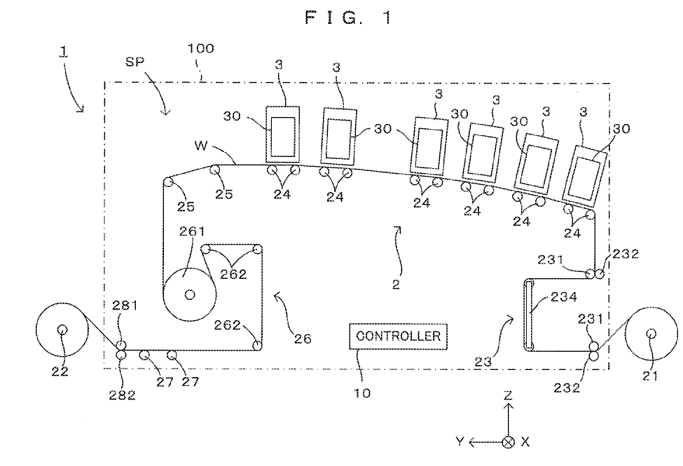

FIG. 1 is an elevational view schematically showing one example of a printer in accordance with the present disclosure. In FIG. 1 and the following figures, an X direction which is a horizontal direction, a Y direction which is a horizontal direction orthogonal to the X direction, and a Z direction which is a vertical direction are shown as appropriate. A printer 1 prints an image on a long strip-like web (base material) W by ejecting ink onto by an inkjet method while transferring the web W in a roll-to-roll manner in a cabinet 100. The material of the web W is paper or a film and the web W has flexibility. The printer 1 includes a controller 10 for generally controlling the whole apparatus, and the control required for a printing operation on the web W is performed by the controller 10. The controller 10 is formed of a processor such as a CPU (Central Processing Unit) or the like.

The printer 1 includes a transfer part 2 for transferring the web W. The transfer part 2 has a feed-out roller 21 and a winding roller 22, and the web W fed out from the feed-out roller 21 is wound around the winding roller 22, to be thereby transferred in a roll-to-roll manner. This transfer part 2 incudes a capture part 23 for capturing the web W fed out from the feed-out roller 21 between the feed-out roller 21 and the winding roller 22. The capture part 23 has two driving rollers 231, two nip rollers 232, and an edge position adjustment part 234 provided between the two driving rollers 231. Each of the driving rollers 231 is rotated by a driving force of a motor while winding the web W, to thereby drive the web W. The two nip rollers 232 are provided corresponding to the two driving rollers 231, respectively, and each of the nip rollers 232 sandwiches the web W with the corresponding driving roller 231. The edge position adjustment part 234 adjusts the position of an end of the web W in the X direction which is a width direction of the web W.

Further, the transfer part 2 has a plurality of support rollers 24 for supporting the web W between the capture part 23 and the winding roller 22. These support rollers 24 transfer the web W in the Y direction while supporting the web W from below, onto which ink is ejected by an inkjet method. Especially, the plurality of support rollers 24 are arranged, being inclined so that the support roller 24 positioned on the more downstream side in a transfer direction (Y direction) of the web W should be positioned higher. Therefore, the web W transferred by these support rollers 24 is transferred inclinedly so as to ascend as goes toward the Y direction.

Further, the transfer part 2 has a plurality of support rollers 25 for supporting the web W between these support rollers 24 and the winding roller 22 and a drying part 26 disposed between these support rollers 25 and the winding roller 22. The drying part 26 has a heat drum 261 and support rollers 262 for supporting the web W going from the heat drum 261 toward the winding roller 22. The heat drum 261 is rotationally driven in response to the transfer of the web W, and dries the web W by heating the web W with an incorporated heater. Furthermore, the transfer part 2 has a plurality of support rollers 27 for supporting the web W going from the drying part 26 toward the winding roller 22. Moreover, the transfer part 2 has a driving roller 281 and a nip roller 282 arranged between these support rollers 27 and the winding roller 22. The driving roller 281 is rotated by the driving force of the motor while winding the web W, to thereby drive the web W. The nip roller 282 sandwiches the web W with the driving roller 281.

Thus, the transfer part 2 forms a transfer path of the web W by the combination of the plurality of rollers and transfers the web W along the transfer path. Most of the transfer path is formed in an internal space SP inside the cabinet 100, but part of the transfer path, for example, at least one of the feed-out roller 21 and the winding roller 22 may be provided outside the cabinet 100. By providing the rollers thus, it is possible to increase the workability of mounting or demounting the roll-type web W on/from the feed-out roller 21 and the winding roller 22.

The printer 1 has a plurality of head units 3 facing the web W supported by the plurality of support rollers 24 inside the cabinet 100, from above. Though described later in detail, each head unit 3 includes a print head 30 for ejecting ink downward from an ejection port (nozzle) provided in a lower portion thereof to attach the ink onto the web W being transferred therebelow. For example, the print heads 30 provided in each head unit 3 eject different color inks, to thereby achieve color printing. Though six head units 3 are arranged along the transfer path in this exemplary case, the number of head units 3 to be arranged is not limited to this number but may be arbitrarily determined. Further, combination of the types of ink to be ejected from the respective print heads 30 may be also arbitrarily determined. Moreover, a plurality of print heads may be provided in one head unit.

As shown in FIG. 1, respective angles of the plurality of head units 3 with respect to the horizontal direction (Y direction) are different from one another. The head units 3, however, can have a common configuration, other than the angles thereof. Then, in the following description on the head units 3, unless otherwise specified, the difference among the angles of the head units 3 will be ignored.

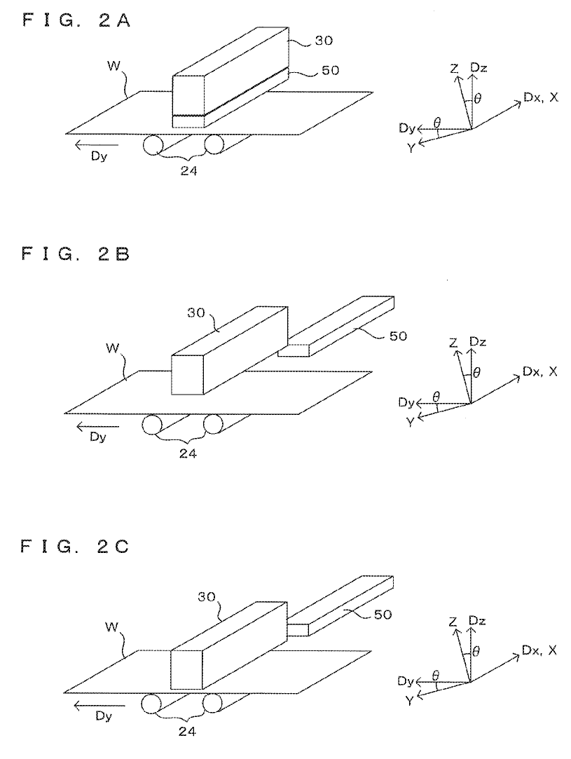

As shown in FIGS. 2A-2C, the printer 1 includes a maintenance part 50 for performing maintenance on the head unit 3. Herein, FIGS. 2A-2C are schematic views each showing a positional relationship among the print head in the head unit, the maintenance part, and the web. In the printer 1, a plurality of maintenance parts 50 are disposed corresponding to the plurality of head units 3, respectively, and each maintenance part 50 performs maintenance on the corresponding head unit 3. The maintenance part 50 is disposed at an angle in accordance with the corresponding head unit 3, and respective angles of the plurality of maintenance parts 50 with respect to the Y direction are different from one another. The maintenance parts 50, however, can have a common configuration, other than the angles thereof. Then, in the following description on the maintenance parts 50, unless otherwise specified, the difference among the angles of the maintenance parts 50 will be ignored.

In FIGS. 2A-2C, shown are a length direction Dx, a width direction Dy, and a height direction Dz of the maintenance part 50. The length direction Dx, the width direction Dy, and the height direction Dz are orthogonal to one another. The length direction Dx is in parallel to the X direction, the width direction Dy is inclined at an angle θ with respect to the Y direction, and the height direction Dz is inclined at an angle θ with respect to the Z direction. In other words, shown is a state where the maintenance part 50 is disposed, being inclined at the angle θ with respect to the Y direction. In order to prevent the gravity from affecting the inkjet ejection of ink, the inclination of the maintenance part 50 is suppressed and the height direction Dz does not largely deviate from the Z direction. Therefore, the arrow-indicating side in the height direction Dz is regarded as an upper side in the height direction Dz and an opposite side to the arrow-indicating side in the height direction Dz is regarded as a lower side in the height direction Dz.

The web W supported by the support rollers 24 faces the print head 30 from below. Then, with a front surface (printed surface) of the web W facing upward, the web W is transferred by the support rollers 24. A direction of the rotation axis of each support roller 24 is in parallel to the horizontal direction, and more specifically, the X direction. Therefore, the web W is transferred in the width direction Dy orthogonal to the X direction.

FIG. 2A shows a standby state in which no printing operation is performed. In the standby state, the print head 30 is retracted upward from the web W which is supported and transferred by the support roller 24, and between the web W and the print head 30, formed is a space wider than the height of the maintenance part 50. On the other hand, the maintenance part 50 is positioned between a lower surface of the print head 30 and an upper surface of the web W.

From the standby state shown in FIG. 2A, the maintenance part 50 is retractable from between the web W and the print head 30 by moving in the X direction (FIG. 2). The lower side of the print head 30 thereby becomes open and the lower surface of the print head 30 faces the web W. Further, as described later, as the maintenance part 50 moves in the X direction along the lower surface of the print head 30, the maintenance part 50 performs a maintenance operation on the nozzles provided in the lower surface of the print head 30. Further, a cleaning operation on the maintenance part 50 is performed at the same time.

Furthermore, the print head 30 is liftable and lowerable. In a state where the print head 30 has descended to the lowest position, as shown in FIG. 2C, the lower surface of the print head 30 gets closer to and face the upper surface of the web W. In this state, ink is ejected from the nozzle, to perform printing on the web W. In the later description, the position of the print head 30 at that time will be referred to as a "printing position". After the printing is ended, the print head 30 moves upward again and the maintenance part 50 moves to between the print head 30 and the web W. The state thereby returns to the standby state shown in FIG. 2A.

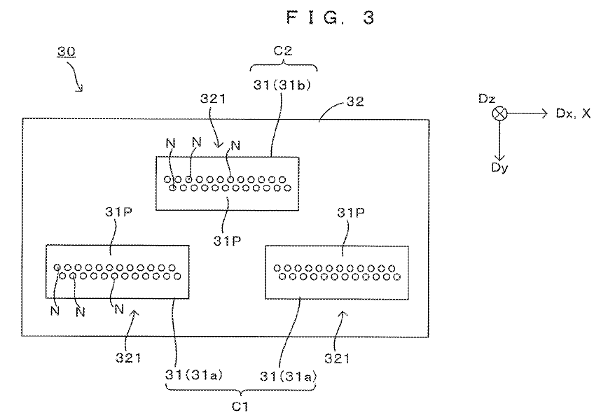

FIG. 3 is a bottom view schematically showing a configuration of the print head. The print head 30 has a plurality of (three in this example) nozzle blocks 31. The plurality of nozzle blocks 31 are arranged in a two-row staggered manner in the X direction. In other words, a nozzle block row C1 consisting of two nozzle blocks 31 arranged in parallel to the X direction and a nozzle block row C2 consisting of one nozzle block 31 arranged in parallel to the X direction are provided at a predetermined interval in the width direction Dy.

The print head 30 has a holding member 32 for holding the plurality of nozzle blocks 31. The holding member 32 has a plurality of insertion holes 321 provided corresponding to the plurality of nozzle blocks 31, respectively, and each of the plurality of nozzle blocks 31 is fixed to the holding member 32, being inserted into the corresponding insertion hole 321. This holding member 32 can be formed of an inelastic member such as a metal or a resin. Further, the nozzle blocks 31 constitute the nozzle block row C1 are referred to as "nozzle blocks 31a" and the nozzle block 31 constitutes the nozzle block row C2 is referred to as a "nozzle block 31b".

On a lower surface of each nozzle block 31, provided is a nozzle opening plane 31P facing the upper surface of the web W from above. In this nozzle opening plane 31P, a plurality of nozzles N (ink ejecting nozzles) are arranged in a staggered manner in the X direction. The nozzle N opens downward in the nozzle opening plane 31P and ejects ink downward by an inkjet method.

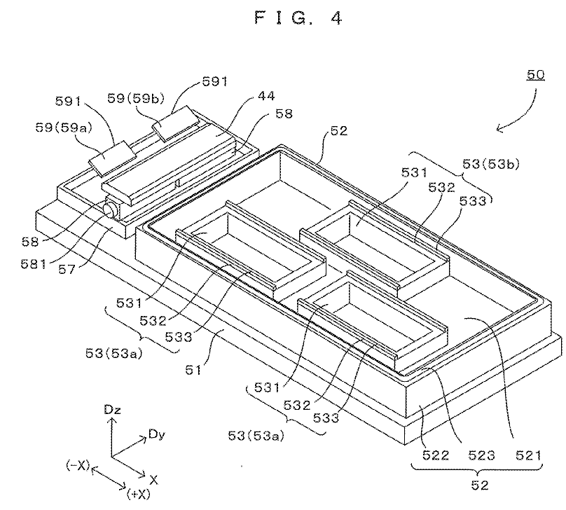

FIG. 4 is a perspective view schematically showing a configuration of the maintenance part. In FIG. 4, shown are a (+X) direction and a (-X) direction which are each in parallel to the X direction and face opposite to each other. As described earlier, the maintenance parts 50 are provided corresponding to the plurality of print heads 30, respectively, and each maintenance part 50 faces the corresponding print head 30 from below. The plurality of maintenance parts 50 provided corresponding to the plurality of print heads 30 have a common configuration. Then, description will be made on one maintenance part 50.

The maintenance part 50 has a base member 51 having a rectangular parallelepiped shape elongated in the X direction. Further, the maintenance part 50 has vats 52 and 57 disposed on the base member 51. The vats 52 and 57 are arranged in the X direction and the vat 52 is positioned on the (+X) direction side of the vat 57. The vat 52 is larger than the vat 57. Each of the vats 52 and 57 has a box shape opening upward and receives ink and various processing liquids ejected from the nozzle block 31.

Inside the larger vat 52, a plurality of caps 53 are disposed. These plurality of caps 53 are provided corresponding to the plurality of nozzle blocks 31 in the print head 30, respectively. Further, the cap 53 corresponding to the nozzle block 31a is referred to as a "cap 53a" and the cap 53 corresponding to the nozzle block 31b is referred to as a "cap 53b". The vat 52 has a bottom plate 521 having a rectangular shape in a plan view and a side wall 522 standing upward from a peripheral portion of the bottom plate 521. The side wall 522 is a frame body having a rectangular shape in a plan view. An elastic member 523 is attached to the entire circumference at an upper end of the side wall 522.

The cap 53 has a cap main body 531 formed in a box shape corresponding to the external shape of the nozzle block 31. This cap main body 531 has an opening which opens upward. At an upper end of the cap main body 531, standing members 532 are so provided as to sandwich this opening from opposite sides in the width direction Dy, and each standing member 532 stands upward. Then, a seal member 533 is attached to a top of each standing member 532. As the seal member 533, for example, a strip-like rubber component can be used.

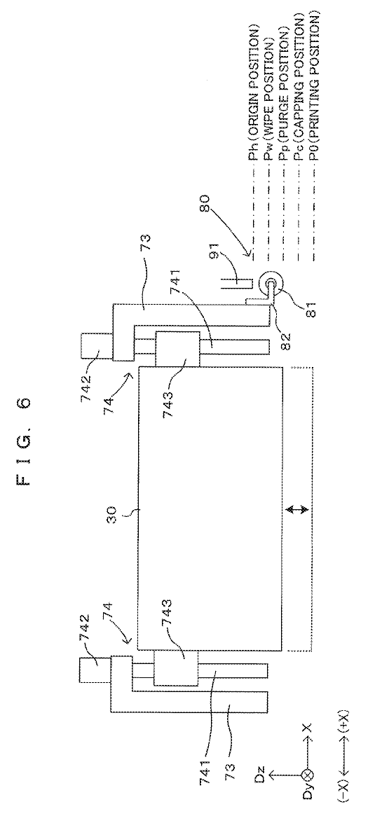

In the standby state (FIG. 2A) where the maintenance part 50 faces the print head 30 from below, the plurality of caps 53 face the plurality of corresponding nozzle blocks 31, respectively, from below. Further, though not clearly shown in FIG. 4, each cap 53 is supported, while being urged upward, by an urging member 56 disposed on the bottom plate 521 of the vat 52. The urging member 56 is, for example, a compression spring. For this reason, when the print head 30 is positioned at a capping position Pc (FIG. 6) in the height direction Dz, as described later, each cap 53 caps the corresponding nozzle block 31. At that time, by an urging force of the urging member 56, the seal member 533 comes into contact with the lower surface portion of the print head 30.

Further, when the print head 30 is positioned at a purge position Pp (FIG. 6) above the capping position Pc, the elastic member 523 goes downward away from the lower surface portion of the print head 30, to thereby make a state where only the seal member 533 comes into contact with the lower surface portion of the print head 30. In this state, by ejecting ink from each nozzle N as necessary, the purge process can be performed.

The ink ejected into the cap 53 is discharged through a not-shown discharge mechanism. As to such a discharge mechanism and a purge process performed by the discharge mechanism, for example, those shown in Japanese Patent Application Laid Open Gazette No. 2022-052195 which is precedently disclosed by the present applicant can be suitably applied. For this reason, description on this mechanism and the purge process will be omitted.

As shown in FIG. 4, inside the smaller vat 57, a lifting and lowering mechanism 58, a wiper blade 59 supported by the lifting and lowering mechanism 58 in a liftable-and-lowerable manner, and a squeezing block 44 are arranged. As described later, the lifting and lowering mechanism 58 lifts and/or lowers the wiper blade 59 in the height direction Dz by using a motor 581. Two lifting and lowering mechanisms 58 and two wiper blades 59 are provided corresponding to the two nozzle block rows C1 and C2, respectively. Further, the wiper blade 59 corresponding to the nozzle block 31a is referred to as a "wiper blade 59a" and the wiper blade 59 corresponding to the nozzle block 31b is referred to as a "wiper blade 59b". The controller 10 controls the lifting and lowering mechanism 58 to adjust the position of the wiper blade 59 in the height direction Dz. The squeezing block 44 is positioned on the (+X) direction side of the two wiper blades 59 and disposed above the lifting and lowering mechanism 58. The detail of the squeezing block 44 will be described later.

When the print head 30 is positioned at a wipe position Pw (FIG. 6) above the purge position Pp, the cap 53 is separated away from the print head 30. Further, a top 591 (upper end) of the wiper blade 59 is positioned at a position slightly higher than the lower surface of the nozzle block 31, i.e., the nozzle opening plane 31P (FIG. 3). In this state, when the maintenance part 50 moves in the (+X) direction, the top 591 of the wiper blade 59 slidingly rubs the nozzle opening plane 31P of the nozzle block 31. The ink adhering to the nozzle opening plane 31P is thereby wiped off by the wiper blade 59 and the nozzle opening plane 31P is cleaned. The maintenance part 50 moves to the (+X) direction side relative to an end surface of the print head 30 and performs cleaning of the nozzle opening plane 31P for all the nozzle blocks 31.

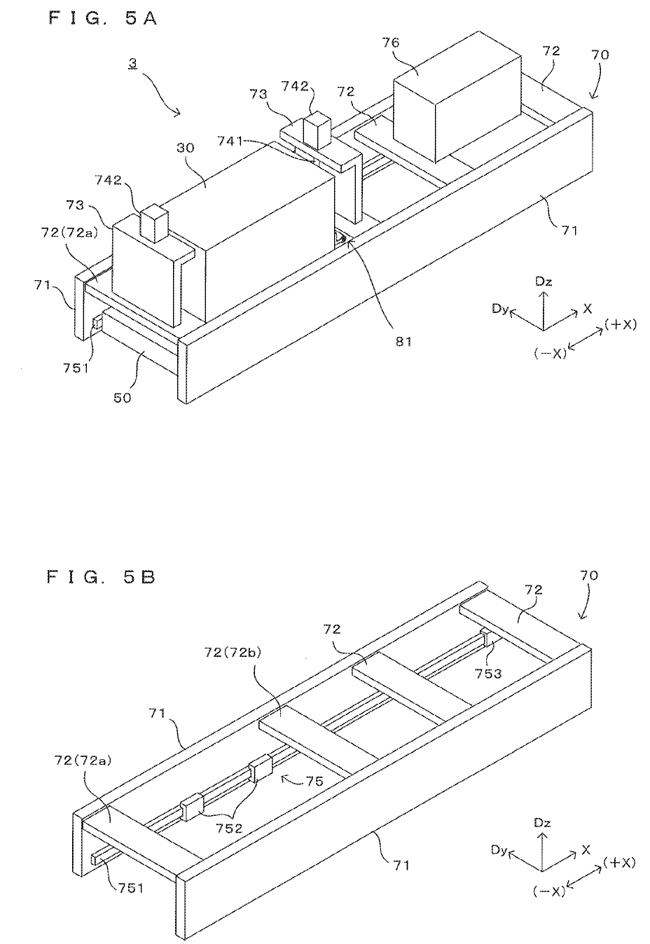

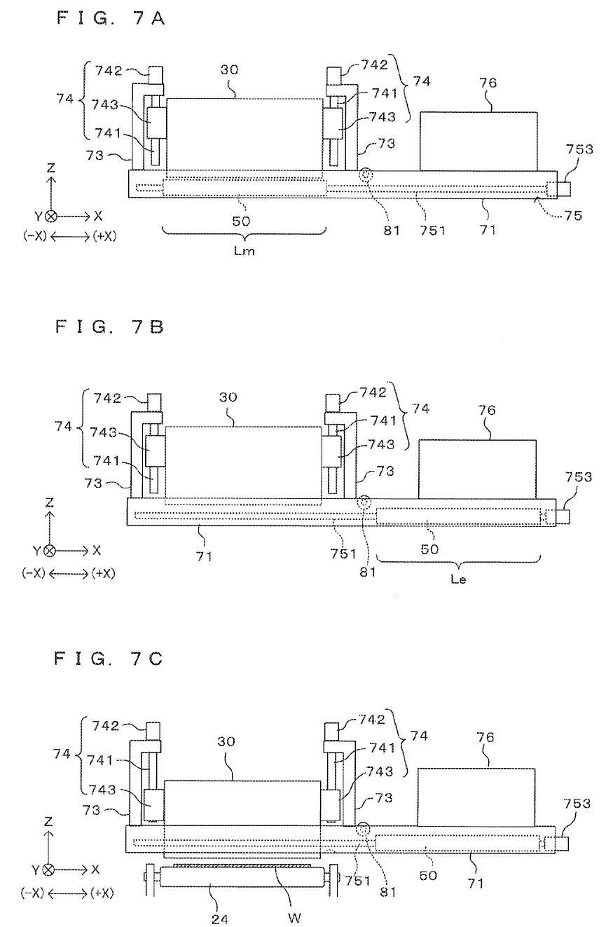

Next, the structure of the head unit 3 will be described in more detail with reference to FIGS. 5A, 5B, 6, 7A, 7B, and 7C, FIG. 5A is a perspective view showing an appearance of the head unit 3, and FIG. 5B is an external perspective view showing a frame 70 in the head unit 3. The head unit 3 has a structure in which various components are attached to the frame 70 shown in FIG. 5B. For clearly showing a frame structure shielded by these components, a structure in which some components are attached to the frame 70 before main components are assembled therein is shown in FIG. 5B. Further, FIG. 6 is a side elevational view showing the head unit 3. FIGS. 7A-7C are side elevational views each showing an operation of the head unit 3.

As shown in FIG. 5B, the frame 70 has a pair of frame members 71 which are so arranged as to face each other with a gap therebetween in the width direction Dy. Each frame member 71 is extended in parallel to the X direction. Further, the frame 70 has a plurality of horizontal members 72 extended in the width direction Dy between the pair of frame members 71 and each horizontal member 72 connects the pair of frame members 71 to each other. The shape of the frame member 71 and the shape, the arrangement, the number, and the like of the horizontal member 72 are not limited to those shown in this figure and may be arbitrarily determined. As described later, however, the maintenance part 50 reciprocates between the pair of frame members 71 in the X direction. Therefore, it is desirable to form such a configuration as not to block the movement of the maintenance part 50.

On the (-X) direction side of the frame member 71, the two horizontal members 72 (72a and 72b) are arranged with a predetermined gap therebetween in the X direction. This gap is longer than the length of the print head 30 in the X direction. To respective upper surfaces of these horizontal members 72a and 72b, attached are head support side plates 73 and 73 for supporting the print head 30 in a liftable-and-lowerable manner.

Further, as shown in FIG. 6, the head support side plates 73 and 73 are provided with lifting and lowering mechanisms 74 and 74, respectively. The lifting and lowering mechanism 74 includes a ball screw 741 extended in the height direction Dz, a motor 742 for rotationally driving the ball screw 741, and a lifting and lowering block 743 attached to a nut of the ball screw 741. Then, the lifting and lowering block 743 is attached to an end portion of the print head 30 in the X direction. Such lifting and lowering mechanisms 74 are disposed on both sides of the print head 30 in the X direction. Therefore, the controller 10 rotates the motors 742 and 742 in synchronization with each other, to thereby lift and/or lower the print head 30 in the height direction Dz together with the lifting and lowering blocks 743 and 743.

Further, the printer 1 includes a cleaning part 80 attached to an end portion of the head support side plate 73 on the (+X) direction side. This cleaning part 80 does not lift or lower as the print head 30 lifts and/or lowers.

The controller 10 lifts and/or lowers the print head 30 in the height direction Dz by using the motors 742 and 742. The controller 10 can thereby position the print head 30 at each of the capping position Pc, the purge position Pp, the wipe position Pw, a printing position P0, and an origin position Ph. The capping position Pc, the purge position Pp, and the wipe position Pw are as described above. The printing position P0 is a position at which printing is performed by the print head 30. The origin position Ph is a position at which the print head 30 is retracted upward.

Further, as shown in FIG. 6, in the present specification, with a height position of the lower surface of the print head 30 in the height direction Dz as the reference, the capping position Pc, the purge position Pp, the wipe position Pw, the printing position P0, and the origin position Ph are defined. The capping position Pc is above the printing position P0, the purge position Pp is above the capping position Pc, the wipe position Pw is above the purge position Pp, and the origin position Ph is above the wipe position Pw.

As shown in FIG. 5B, on an inner surface of each of the pair of frame members 71, attached is a guide rail 751 extended in the X direction. A slider 752 is movably engaged with this guide rail 751 in the X direction. Further, a motor 753 for driving the slider 752 in the X direction is provided. Then, the maintenance part 50 is attached to the slider 752.

Therefore, the controller 10 can control the motor 753 to move the maintenance part 50 in the X direction. Specifically, the maintenance part 50 moves in the X direction along the guide rail 751 between the pair of frame members 71, as shown in FIGS. 7A and 7B. Thus, the guide rail 751, the slider 752, and the motor 753 serve as a moving mechanism 75 for moving the maintenance part 50 in the X direction. As such a moving mechanism 75, an appropriate mechanism such as a linear motor, a ball-screw mechanism, an air cylinder, a belt drive mechanism, or the like can be selected and used.

The head unit 3 having such a configuration can enter one of respective states shown in FIGS. 7A, 7B and 7C. In the state shown in FIG. 7A, the print head 30 is retracted upward and the maintenance part 50 is positioned at a maintenance position Lm facing the print head 30 from below. In the state shown in FIG. 7B, the maintenance part 50 is positioned at an escape position Le which is retracted from the maintenance position Lm toward the (+X) direction. In the state shown in FIG. 7C, the maintenance part 50 is retracted to the escape position Le and the print head 30 descends to below the frame member 71. As can be seen from the comparison with FIGS. 2A-2C, the state shown in FIG. 7A corresponds to that in FIG. 2A, the state shown in FIG. 7B corresponds to that in FIG. 2B, and the state shown in FIG. 7C corresponds to that in FIG. 2C.

Referring back to FIG. 5A, description on the head unit 3 will continue. An electrical box 76 is attached on the (+X) direction side of the frame member 71. In the electrical box 76, accommodated are various equipment for properly operating the head unit 3, such as a control circuit for controlling the print head 30 and the moving mechanism 75, a pump for sending out ink toward the print head 30, a power supply circuit for supplying power thereto, and the like. By attaching the electrical box 76 including these components to the frame member 71 as a unit with the print head 30, it is possible to reduce the length of a pipe, a cable, or the like to the print head 30 and thereby possible to achieve a stable operation.

Further, as described above, the head unit 3 has the cleaning part 80 provided on the side surface of the head support side plate 73 on the (+X) direction side. This cleaning part 80 removes ink from the cap 53 and the wiper blade 59 provided in the maintenance part 50. Subsequently, the cleaning part 80 will be described in detail.

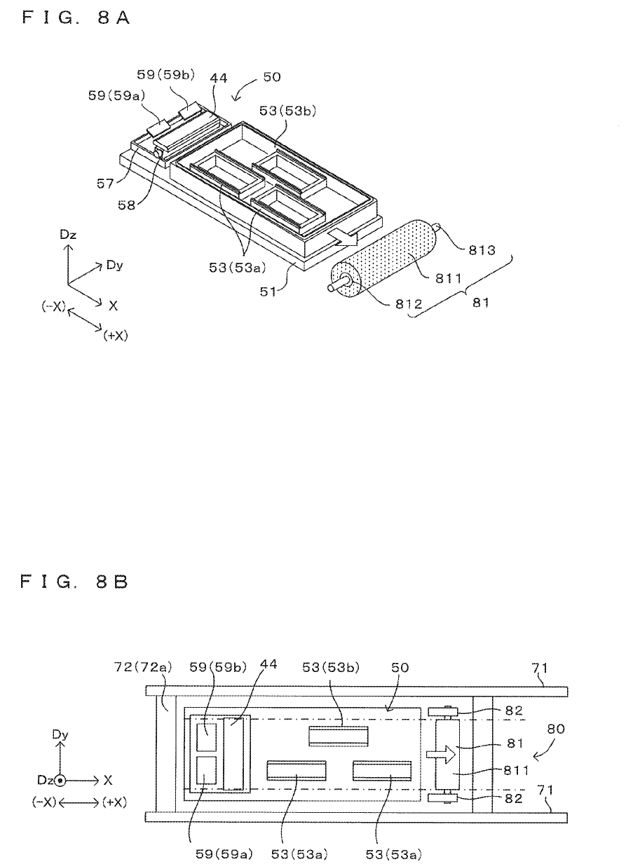

FIG. 8A is a perspective view schematically showing a configuration of the maintenance part and the cleaning part. FIG. 8B is a plan view schematically showing the configuration of the maintenance part and the cleaning part. These figures do not clearly show the print head 30, the head support side plate 73, or the lifting and lowering mechanism 74. As described above, however, the cleaning part 80 is attached to the side surface of the head support side plate 73 on the (+X) direction side. This cleaning part 80 comes into contact with a cleaning target portion of the maintenance part 50 moving in the X direction, to thereby clean this cleaning target portion.

The cleaning part 80 has a cleaning roller 81 and a pair of bearing members 82. The pair of bearing members 82 are attached to the side surface of the head support side plate 73 on the (+X) direction side of the print head 30, to support the cleaning roller 81 rotatably.

The cleaning roller 81 has a surface layer 811 on an outer peripheral surface thereof. The surface layer 811 is a sponge, which is a porous member, and has liquid retention to retain the cleaning solution and elasticity. Therefore, the cleaning roller 81 can absorb ink. Specifically, the cleaning roller 81 has a metal cored bar 812 having a cylindrical shape in parallel to the width direction Dy, and the cylindrical surface layer 811 is disposed around the cored bar 812. A rotation axis 813 is provided to be coaxial with a center of the cored bar 812 and both ends of the rotation axis 813 are pivotally supported by the pair of bearing members 82 and 82.

In the width direction Dy, the surface layer 811 of the cleaning roller 81 has a length which corresponds to an interval between a pair of one-dot chain lines in FIG. 8B. As shown in FIG. 8B, in the width direction Dy, the seal member 533 of the cap 53 and the top 591 of the wiper blade 59 are included between both ends of the cleaning roller 81 (the pair of one-dot chain lines). A locus of the seal member 533 at the time when the maintenance part 50 moves in the (+X) direction overlaps the surface layer 811 of the cleaning roller 81. Further, a locus of the top 591 of the wiper blade 59 at the time when the maintenance part 50 moves in the (+X) direction overlaps the surface layer 811 of the cleaning roller 81. In other words, during a cleaning process, the surface layer 811 of the cleaning roller 81 comes into contact with a top of the cleaning target portion (the seal member 533 and the wiper blade 59) of the maintenance part 50 from above.

In the width direction Dy, the width of the squeezing block 44 is slightly larger than that of the surface layer 811 of the cleaning roller 81. Specifically, in the width direction Dy, the surface layer 811 of the cleaning roller 81 is included between both ends of the squeezing block 44. The dimensional relationship of these components, however, is not limited to this example. Therefore, the width of the surface layer 811 may be equal to that of the squeezing block 44 or may be smaller than that of the squeezing block 44. A locus of the squeezing block 44 at the time when the maintenance part 50 moves in the (+X) direction overlaps the cleaning roller 81. In other words, during the cleaning process, the surface layer 811 of the cleaning roller 81 comes into contact with the squeezing block 44 from above.

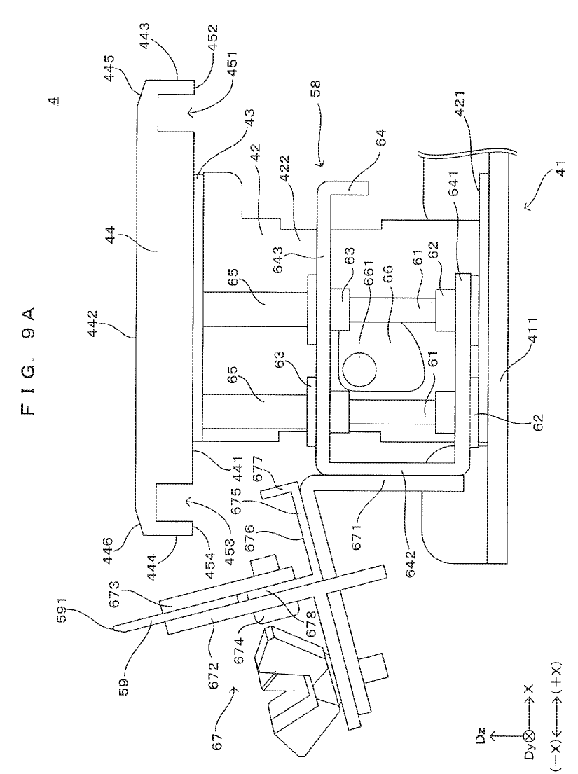

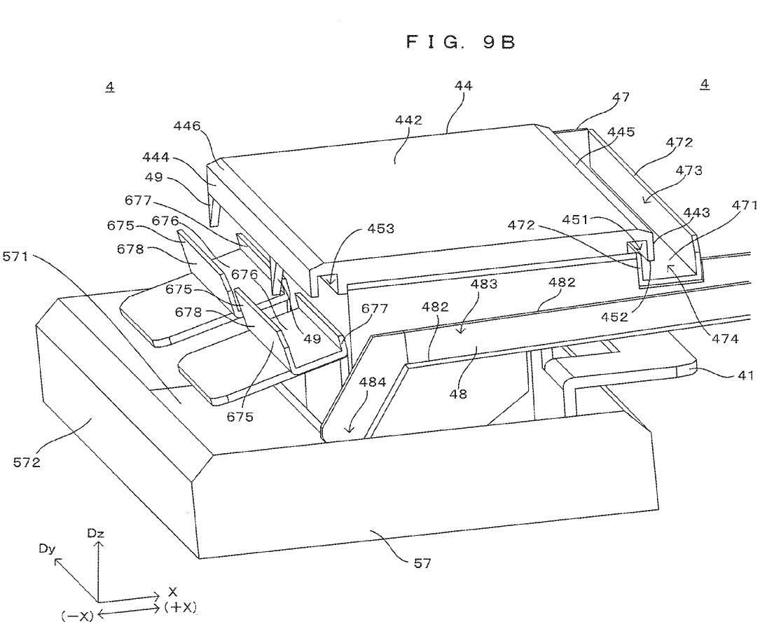

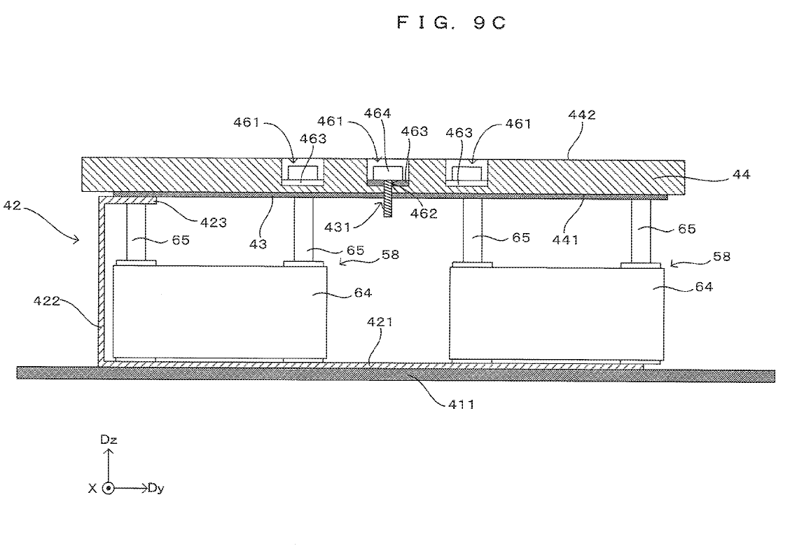

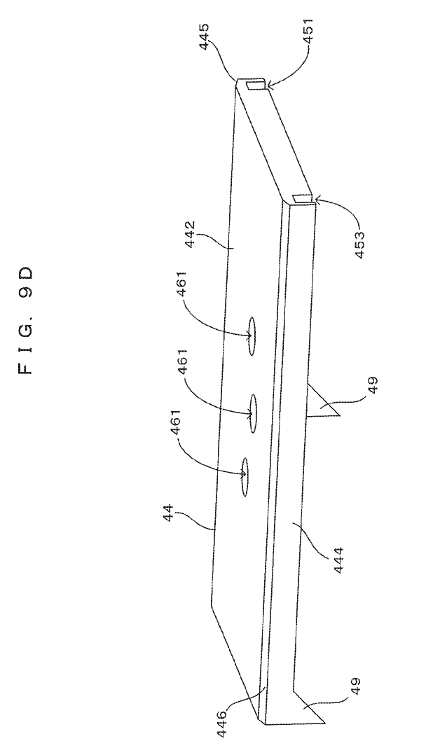

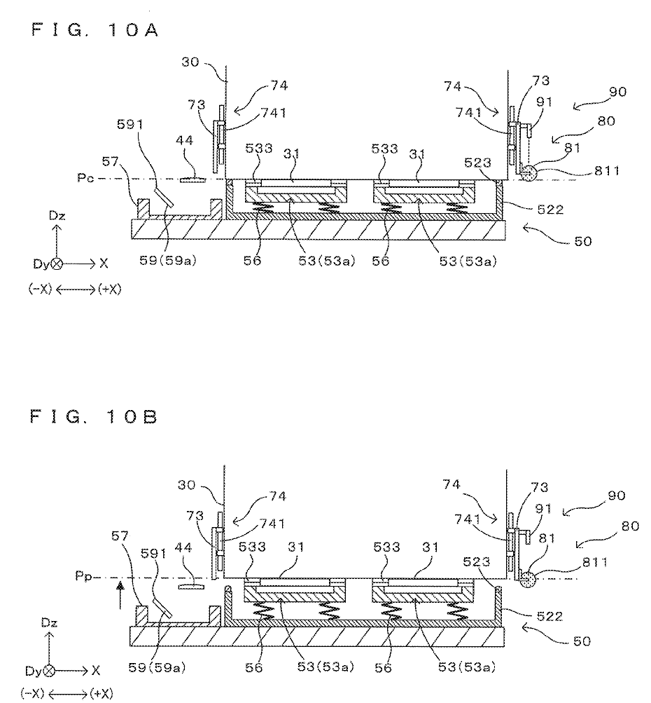

Thus, the printer 1 includes the squeezing block 44. This squeezing block 44 is provided to squeeze ink (specifically, ink mixed in the cleaning solution) from the surface layer 811 of the cleaning roller 81. In the printer 1, especially, the squeezing block 44 is unitized together with the above-described vat 57, lifting and lowering mechanism 58, and wiper blade 59, to thereby form an ink collection unit 4 described below (FIGS. 9A-9D).

FIG. 9A is a partial side elevational view schematically showing the ink collection unit included in the printer shown in FIG. 1, FIG. 9B is a partial perspective view schematically showing the ink collection unit included in the printer shown in FIG. 1, FIG. 9C is a partial cross-sectional view schematically showing the ink collection unit included in the printer shown in FIGS. 1 and 9D is a perspective view schematically showing the squeezing block included in the ink collection unit shown in FIGS. 9A-9C.

As shown in FIG. 9B, the ink collection unit 4 includes the vat 57. The vat 57 has a bottom plate 571 disposed in parallel to the X direction and the width direction Dy and a side wall plate 572 standing from a periphery of the bottom plate 571 in the height direction Dz, and opens upward in the height direction Dz.

The ink collection unit 4 includes the above-described lifting and lowering mechanism 58 (FIG. 9A). The lifting and lowering mechanism 58 is disposed inside the vat 57 and surrounded by the side wall plate 572 of the vat 57. Further, the lifting and lowering mechanism 58 is provided for each of the two wiper blades 59 as described above.

The ink collection unit 4 has a support frame 41 attached to the side wall plate 572 of the vat 57 and a mounting frame 42 supported by the support frame 41, and the lifting and lowering mechanism 58 is supported by the support frame 41 through the mounting frame 42. The support frame 41 has a support plate 411 disposed inside the vat 57. The support plate 411 faces the bottom plate 571 from above with a gap between the support plate 411 and the bottom plate 571. Thus, a space is provided between the support plate 411 and the bottom plate 571 and the ink collected in the vat 57 is stored in this space.

As shown in FIG. 9C, the mounting frame 42 has a base plate 421, a standing plate 422, and a mounting plate 423. The base plate 421 is disposed in parallel to the X direction and the width direction Dy and attached to an upper surface of the support plate 411 of the support frame 41. The standing plate 422 stands upward in the height direction Dz from an end portion of the base plate 421 on one side in the width direction Dy. The mounting plate 423 protrudes toward the other side in the width direction Dy from an upper end of the standing plate 422.

Further, the ink collection unit 4 includes a cover plate 43 attached to the mounting plate 423. The cover plate 43 is provided in parallel to the X direction and the width direction Dy. The cover plate 43 faces the base plate 421 of the mounting frame 42 from above in the height direction Dz with a gap between the cover plate 43 and the base plate 421.

The lifting and lowering mechanism 58 is supported by the mounting frame 42 provided thus on the support plate 411. The lifting and lowering mechanism 58 has a plurality of (two) shafts 61 standing upward in parallel to the height direction Dz from the base plate 421 (FIG. 9A). Further, the number of shafts 61 is not limited to plural but may be one. Each shaft 61 is extended in the height direction Dz between the base plate 421 and the cover plate 43, a lower end of the shaft 61 is attached to the base plate 421, and an upper end of the shaft 61 is attached to the cover plate 43.

The lifting and lowering mechanism 58 has a pair of linear bushings 62, 63 provided corresponding to each of the plurality of shafts 61. The shaft 61 is inserted into the pair of linear bushings 62, 63 corresponding to this shaft 61. The linear bushings 62, 63 are provided between the base plate 421 and the cover plate 43 in the height direction Dz and the linear bushing 63 is provided above the linear bushing 62.

The lifting and lowering mechanism 58 has a lifting and lowering frame 64 attached to the linear bushings 62, 63. The lifting and lowering frame 64 has a lower-side plate 641, a connection plate 642, and an upper-side plate 643. The lower-side plate 641 which is in parallel to the X direction and the width direction Dy is attached to the linear bushing 62 into which each shaft 61 is inserted. The upper-side plate 643 which is in parallel to the X direction and the width direction Dy is attached to the linear bushing 63 into which each shaft 61 is inserted. The connection plate 642 is extended in the height direction Dz and connects respective end portions of the lower-side plate 641 and the upper-side plate 643 on the (-X) direction side to each other. Therefore, the lifting and lowering frame 64 is movable in the height direction Dz along the shaft 61 together with the linear bushings 62, 63.

The lifting and lowering mechanism 58 has a spiral spring 65 provided for each shaft 61. The shaft 61 is inserted into the corresponding spring 65. The spring 65 is provided between the upper-side plate 643 of the lifting and lowering frame 64 and the cover plate 43 in the height direction Dz. The spring 65 (compression spring) urges the upper-side plate 643 of the lifting and lowering frame 64 downward in the height direction Dz with respect to the cover plate 43.

The lifting and lowering mechanism 58 has an eccentric cam 66 provided between the upper-side plate 643 and the lower-side plate 641 of the lifting and lowering frame 64 in the height direction Dz. Thus, the eccentric cam 66 faces the upper-side plate 643 from below. The eccentric cam 66 is supported by the mounting frame 42 rotatably about a rotation axis 661 extended in parallel to the width direction Dy. The lifting and lowering mechanism 58 has the motor 581 (FIG. 4) for driving the eccentric cam 66 and causes the motor 581 to rotate the eccentric cam 66.

In a state where the eccentric cam 66 is separated downward from the upper-side plate 643, the lifting and lowering frame 64 is urged downward by the spring 65 to be positioned at a lowered position (FIG. 9A). On the other hand, when the eccentric cam 66 is rotated to come into contact with the upper-side plate 643, the eccentric cam 66 moves the lifting and lowering frame 64 from the lowered position (FIG. 9A) to an upper lifted position against the urging force of the spring 65. Specifically, the controller 10 can control the motor 581 of the lifting and lowering mechanism 58 to lift and lower the lifting and lowering frame 64 between the lowered position and the lifted position in the height direction Dz.

Further, the lifting and lowering mechanism 58 includes a mounting part 67 for mounting the wiper blade 59 onto the lifting and lowering frame 64. The mounting part 67 has an L-shaped bracket 671 attached to the connection plate 642 of the lifting and lowering frame 64 and a mounting stay 672 fastened to the L-shaped bracket 671 with a screw. The mounting stay 672 is supported by the L-shaped bracket 671 on the (-X) direction side relative to the lifting and lowering frame 64.

Furthermore, the mounting part 67 has a plate 673 facing the mounting stay 672 from the (+X) direction side, and the wiper blade 59 is sandwiched between the mounting stay 672 and the plate 673, being in contact with the mounting stay 672 and the plate 673. The mounting stay 672 and the plate 673 are fastened to each other with a screw 674 and support the wiper blade 59 therebetween. Therefore, the controller 10 can control the motor 581 of the lifting and lowering mechanism 58 to lift and lower the wiper blade 59 in the height direction Dz together with the lifting and lowering frame 64.

In the exemplary case shown in FIG. 9A, in the state where the lifting and lowering frame 64 is positioned at the lowered position, the top 591 of the wiper blade 59 is positioned above an upper surface 442 of the squeezing block 44. The positional relationship of these component, however, is not limited to the example shown in FIG. 9A but there may be a configuration where the top 591 of the wiper blade 59 is positioned below the upper surface 442 of the squeezing block 44. On the other hand, in the state where the lifting and lowering frame 64 is positioned at the lifted position, the top 591 of the wiper blade 59 protrudes upward relative to the upper surface 442 of the squeezing block 44.

Further, the mounting part 67 has an ink guide receiver 675 extended in the width direction Dy. The ink guide receiver 675 faces the mounting stay 672 from the (+X) direction side below the wiper blade 59. The ink guide receiver 675 has a bottom plate 676, a side wall 677 standing upward from an end of the bottom plate 676 on the (+X) direction side, and a side wall 678 standing upward from an end of the bottom plate 676 on the (-X) direction side. The side wall 678 of the ink guide receiver 675 is sandwiched between the mounting stay 672 and the plate 673, being in contact with the mounting stay 672 and the plate 673. The mounting stay 672 and the plate 673 are fastened to each other with a screw 674 and support the side wall 678 of the ink guide receiver 675 therebetween. This ink guide receiver 675 receives ink dropping from above by the bottom plate 676.

The squeezing block 44 included in the ink collection unit 4 is attached to an upper surface of the cover plate 43. The squeezing block 44 is a plate having a rectangular shape in a plan view from the height direction Dz. The squeezing block 44 has a lower surface 441 and an upper surface 442, each of which is parallel to the X direction and the width direction Dy. The lower surface 441 and the upper surface 442 face each other in the height direction Dz and the upper surface 442 is positioned above the lower surface 441.

Further, the squeezing block 44 has a side surface 443 and a side surface 444 on both ends of the squeezing block 44 in the X direction, respectively. The side surface 443 is provided at the end of the squeezing block 44 on the (+X) direction side and the side surface 444 is provided at the end of the squeezing block 44 on the (-X) direction side. Each of the side surfaces 443 and 444 is a plane orthogonal to the X direction (in other words, in parallel to the height direction Dy and the height direction Dz). When viewed in the height direction Dz, the lower surface 441 and the upper surface 442 are positioned between the side surfaces 443 and 444 in the X direction.

A corner between the upper surface 442 and the side surface 443 of the squeezing block 44 is chamfered to form an inclined surface 445. Specifically, the inclined surface 445 is a plane extended from an end of the upper surface 442 on the (+X) direction side to an upper end of the side surface 443. The shape of the inclined surface 445, however, is not limited to a plane. The end of the upper surface 442 on the (+X) direction side is positioned above the upper end of the side surface 443, and the inclined surface 445 descends toward the side surface 443 (in other words, toward the (+X) direction). Thus, the inclined surface 445 descending toward the end in the (+X) direction is provided at the end of the squeezing block 44 on the (+X) direction side. This inclined surface 445 is inclined with respect to the X direction which is a moving direction of the maintenance part 50.

A corner between the upper surface 442 and the side surface 444 of the squeezing block 44 is chamfered to form an inclined surface 446. Specifically, the inclined surface 446 is a plane extended from an end of the upper surface 442 on the (-X) direction side to an upper end of the side surface 444. The shape of the inclined surface 446, however, is not limited to a plane. The end of the upper surface 442 on the (-X) direction side is positioned above the upper end of the side surface 444, and the inclined surface 446 descends toward the side surface 444 (in other words, toward the (-X) direction). Thus, the inclined surface 446 descending toward the end in the (-X) direction is provided at the end of the squeezing block 44 on the (-X) direction side. This inclined surface 446 is inclined with respect to the X direction which is the moving direction of the maintenance part 50.

The squeezing block 44 has a recessed portion 451. The recessed portion 451 is provided between a lower end of the side surface 443 in the height direction Dz and an end of the lower surface 441 in the (+X) direction in the X direction. Specifically, in the squeezing block 44, an extended surface 452 is extended from the lower end of the side surface 443 toward the lower surface 441 (i.e., toward the (-X) direction). This extended surface 452 is in parallel to the X direction and the width direction Dy and flush with the lower surface 441. The recessed portion 451 is a hole provided across a range from the extended surface 452 to the lower surface 441, and recessed upward from the lower surface 441 and the extended surface 452. In other words, the recessed portion 451 is a groove extended in parallel to the width direction Dy and opens at both ends of the squeezing block 44 in the width direction Dy.

The squeezing block 44 has a recessed portion 453. The recessed portion 453 is provided between a lower end of the side surface 444 in the height direction Dz and an end of the lower surface 441 in the (-X) direction in the X direction. Specifically, in the squeezing block 44, an extended surface 454 is extended from the lower end of the side surface 444 toward the lower surface 441 (i.e., toward the (+X) direction). This extended surface 454 is in parallel to the X direction and the width direction Dy and flush with the lower surface 441. The recessed portion 453 is a hole provided across a range from the extended surface 454 to the lower surface 441, and recessed upward from the lower surface 441 and the extended surface 454. In other words, the recessed portion 453 is a groove extended in parallel to the width direction Dy and opens at both the ends of the squeezing block 44 in the width direction Dy.

When viewed in the height direction Dz, the recessed portion 451 is positioned outside the lifting and lowering frame 64 of the lifting and lowering mechanism 58 in the (+X) direction, and the recessed portion 453 is positioned outside the lifting and lowering frame 64 of the lifting and lowering mechanism 58 in the (-X) direction. In other words, in the X direction, the lifting and lowering frame 64 of the lifting and lowering mechanism 58 is positioned between the recessed portions 451 and 453.

Further, when viewed in the height direction Dz, the recessed portion 451 is positioned outside the cover plate 43 in the (+X) direction, and the recessed portion 453 is positioned outside the cover plate 43 in the (-X) direction. In other words, in the X direction, the cover plate 43 is positioned between the recessed portions 451 and 453. When viewed in the height direction Dz, in the lifting and lowering mechanism 58, the shaft 61, the linear bushings 62, 63, the spring 65, and the eccentric cam 66 are covered with the cover plate 43.

As shown in FIG. 9C, in the squeezing block 44, a plurality of counterbores 461 (holes) which open in the upper surface 442 are provided, and in each counterbore 461, the squeezing block 44 is attached to the cover plate 43. Specifically, in the squeezing block 44, an insertion hole 462 is provided corresponding to each counterbore 461. This insertion hole 462 is a through hole provided in the height direction Dz, and an upper end of the insertion hole 462 opens to the counterbore 461 and a lower end of the insertion hole 462 opens in the lower surface 441. Further, in the cover plate 43, a screw hole 431 facing the insertion hole 462 is provided in the height direction Dz.

Inside the counterbore 461, a seal washer 463 is disposed. The seal washer 463 is a washer formed of an elastic member having a sealing function. Then, a screw 464 inserted into the seal washer 463 and the insertion hole 462 from above in the height direction Dz is screwed into the screw hole 431, to fasten the squeezing block 44 to the cover plate 43. A screw head of the screw 464 is positioned inside the counterbore 461, and the seal washer 463 is pressed to a bottom surface of the counterbore 461 by screwing of the screw 464 into the screw hole 431. Therefore, a gap between the screw 464 and the insertion hole 462 is sealed by the seal washer 463.

This squeezing block 44 comes into contact with the cleaning roller 81 by the inclined surface 445 or 446, to thereby squeeze ink from the cleaning roller 81. As described later, especially, the squeezing block 44 comes into contact with the surface layer 811 of the cleaning roller 81 while moving in the X direction relative to the cleaning roller 81, to thereby press the surface layer 811. The ink retained in the surface layer 811 of the cleaning roller 81 thereby flows out from the surface layer 811 to the squeezing block 44. In contrast to this, the ink collection unit 4 has a configuration to guide the ink which has flowed out to the inclined surfaces 445 and 446 of the squeezing block 44, to the bottom plate 571 of the vat 57.

The ink collection unit 4 has an ink guide drain 47 disposed on the (+X) direction side of the squeezing block 44. The ink guide drain 47 is extended in the width direction Dy along the side surface 443 of the squeezing block 44. This ink guide drain 47 has a bottom plate 471, a pair of side walls 472 protruding upward in the height direction Dz from both ends of the bottom plate 471 in the X direction. Thus, the ink guide drain 47 has a groove 473 defined by the bottom plate 471 and the pair of side walls 472. This groove 473 opens upward and faces the lower end of the side surface 443 and the extended surface 452 from below. In other words, in a plan view from the height direction Dz, the extended surface 452 is positioned between (inside) the pair of side walls 472 in the X direction. Further, at one end among both ends of the groove 473 in the width direction Dy, an opening 474 toward the width direction Dy is provided. The bottom plate 471 of the ink guide drain 47 is so inclined as to descend toward the opening 474. The ink which has flowed out to the inclined surface 445 of the squeezing block 44 drops into the groove 473 of the ink guide drain 47 from the inclined surface 445 and is received by the bottom plate 471 of the ink guide drain 47. The ink received by the bottom plate 471 flows toward the opening 474 along the inclination of the bottom plate 471 and drops from the opening 474.

The ink collection unit 4 has an ink guide drain 48 disposed for the opening 474 of the ink guide drain 47. The ink guide drain 48 is extended in the X direction. This ink guide drain 48 has a not-shown bottom plate and a pair of side walls 482 protruding upward in the height direction Dz from both ends of the bottom plate in the width direction Dy. Thus, the ink guide drain 48 has a groove 483 defined by the bottom plate and the pair of side walls 482. This groove 483 opens upward and faces, from below, an end of the bottom plate 471 of the ink guide drain 47 provided with the opening 474. Further, at an end of the groove 483 in the (-X) direction among both ends thereof in the X direction, provided is an opening 484 toward the bottom plate 571 of the vat 57. The bottom plate of the ink guide drain 48 is so inclined as to descend toward the opening 484. The ink falling from the opening 474 of the ink guide drain 47 drops into the groove 483 of the ink guide drain 48 and is received by the bottom plate of the ink guide drain 48. The ink received by the bottom plate of the ink guide drain 48 flows toward the opening 484 along the inclination of the bottom plate and drops from the opening 484 onto the bottom plate 571 of the vat 57.

Further, the ink collection unit 4 has a plurality of (two) ink guide protrusions 49 protruding downward in the height direction Dz from the side surface 444 of the squeezing block 44. Furthermore, the number of ink guide protrusions 49 is not limited to plural but may be one. The ink guide protrusion 49 has a shape tapered toward a lower tip in the height direction Dz. Specifically, the ink guide protrusion 49 is extended downward to a lower pointed tip. The two ink guide protrusions 49 face the bottom plates 676 of the two ink guide receivers 675 from above, respectively. The ink which has flowed out to the inclined surface 446 of the squeezing block 44 goes along the side surface 444 and the ink guide protrusion 49 and drops from the tip (lower end) of the ink guide protrusion 49, and is received by the bottom plate 676 of the ink guide receiver 675 facing the ink guide protrusion 49. The ink received by the bottom plate 676 of the ink guide receiver 675 drops from the end of the bottom plate 676 in the width direction Dy onto the bottom plate 571 of the vat 57.

Further, to the bottom plate 676 of the ink guide receiver 675, the ink dropping from the wiper blade 59 adheres. This ink is sometimes dried and solidified on the bottom plate 676. In contrast to this, by guiding the ink which has flowed out from the surface layer 811 of the cleaning roller 81 onto the bottom plate 676 by the ink guide protrusion 49, it becomes possible to wash away the ink solidified on the bottom plate 676.

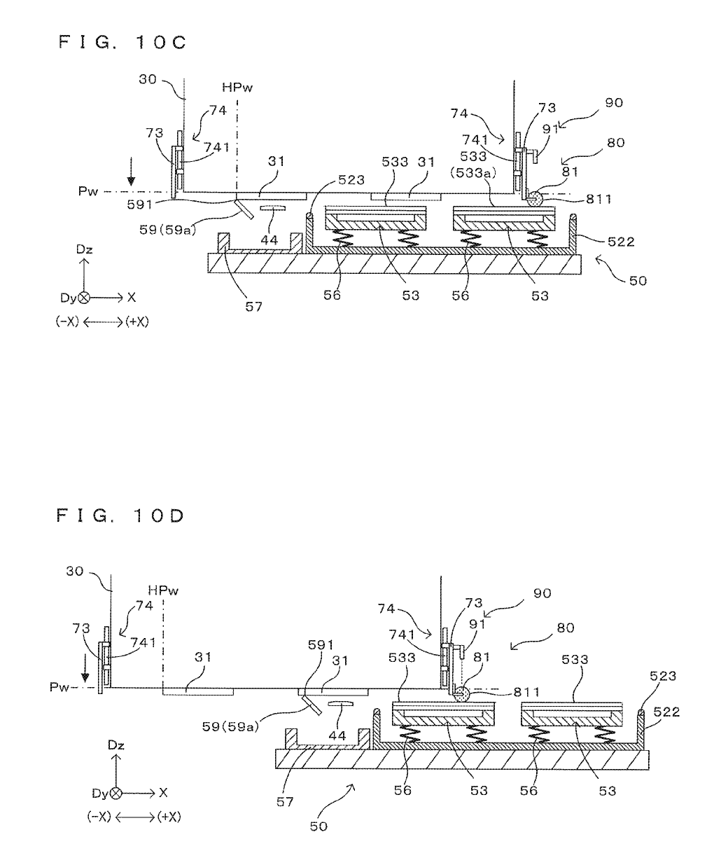

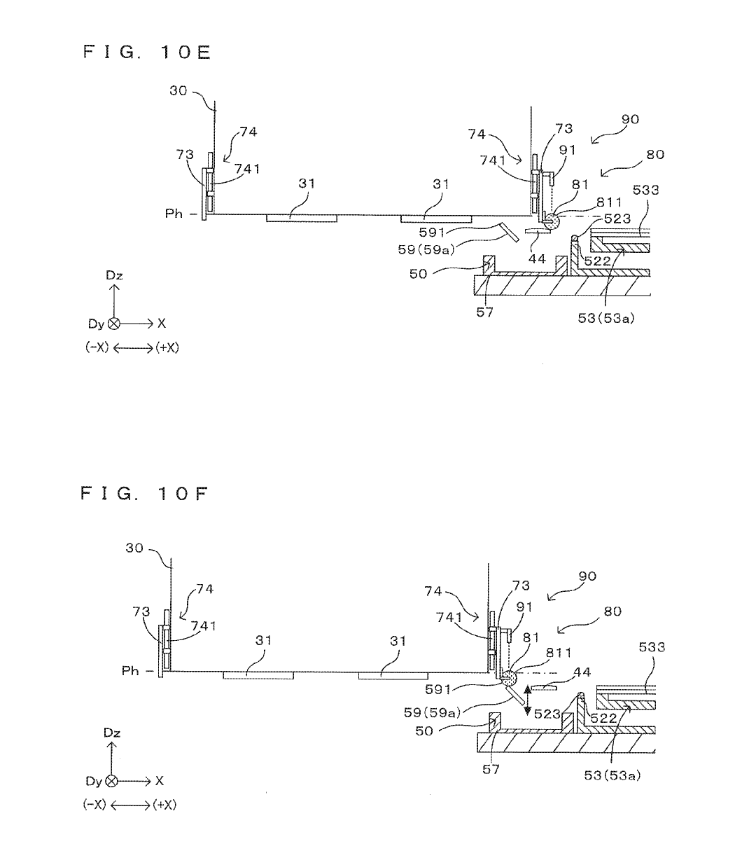

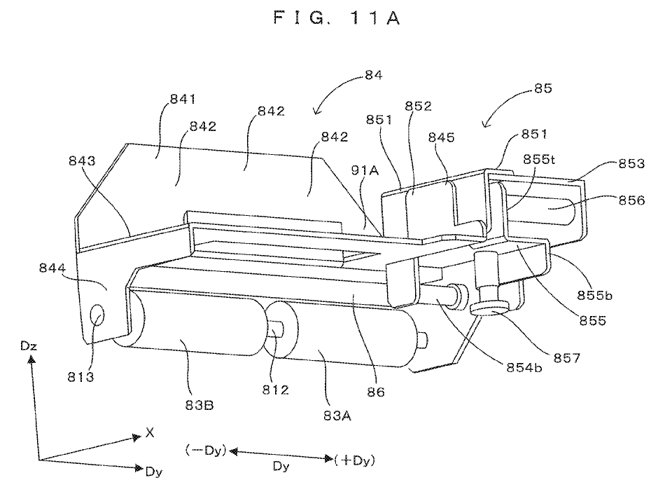

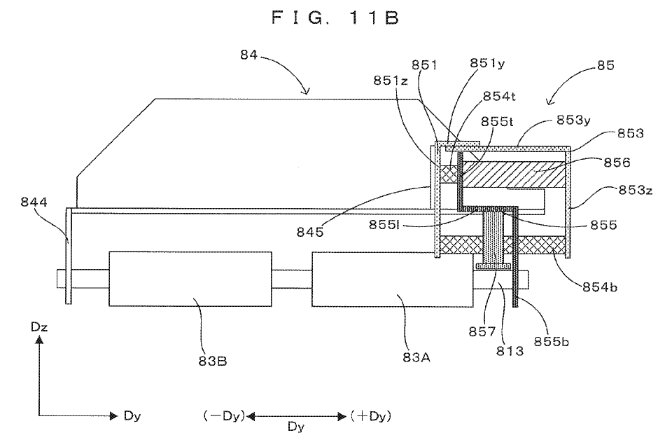

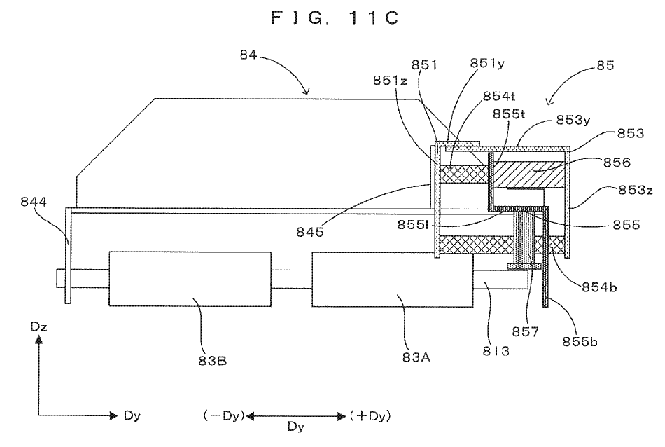

Subsequently, with reference to FIGS. 10-10F, an operation of the maintenance part 50 and the cleaning part 80 will be described in detail. FIGS. 10A-10F are views each schematically showing an operation of the maintenance part and the cleaning part. As shown in FIGS. 10A-10F, the printer 1 includes a cleaning solution supplier 90 for supplying a cleaning solution to the cleaning roller 81. This cleaning solution supplier 90 is attached to a position which is immediately above the cleaning roller 81 and an end of a side surface of the head support side plate 73 on the (+X) direction side. Further, in FIGS. 10A-10F, shown is the cleaning solution supplier 90 which is simplified by only one nozzle 91 (cleaning solution ejection nozzle) facing the surface layer 811 of the cleaning roller 81 from above. The number of nozzles 91 which can be included in the cleaning solution supplier 90, however, is not limited to one but may be plural.

In the standby state shown in FIG. 10A, the maintenance part 50 is positioned at the maintenance position Lm (FIG. 7A) immediately below the print head 30 in the X direction and the print head 30 is positioned at the capping position Pc in the height direction Dz. The elastic member 523 comes into contact with the lower surface of the print head 30. Further, the seal member 533 is brought into contact with the lower surface of the print head 30 by the urging force of the urging member 56.

In this standby state, the controller 10 causes the nozzle 91 of the cleaning solution supplier 90 to eject a cleaning solution, to thereby drop the cleaning solution onto the cleaning roller 81 and wet the surface layer 811 of the cleaning roller 81. Then, after the supply of the cleaning solution to the cleaning roller 81 is completed, the controller 10 stops ejection of the cleaning solution from the nozzle 91.

Thus, in the standby state, the cleaning roller 81 waits while holding the cleaning solution whose amount is suitable for the cleaning process. When the standby state is changed to a maintenance state, as described below in detail, a pressurization purge process and a wiping process are performed, and the cleaning process using the cleaning roller 81 is also performed.

As shown in FIG. 10B, in performing the pressurization purge process, as indicated by an arrow in this figure, the controller 10 lifts the print head 30 from the capping position Pc to the purge position Pp. The elastic member 523 of the vat 52 is thereby separated from the lower surface of the print head 30. On the other hand, the seal member 533 of the cap 53 keeps a contact state with the lower surface of the print head 30, by the urging member 56 elongated upward. Subsequently, the controller 10 causes each nozzle N to eject ink (purge process).

In order to wipe the ink which has flowed out from the nozzle N in this purge process, the controller 10 controls the apparatus components in the following manner, to thereby prepare the wiping process. Specifically, the controller 10 lifts the print head 30 from the purge position Pp to the origin position Ph. In this state, the controller 10 moves the maintenance part 50 in the (+X) direction.

As shown in FIG. 10C, when the top 591 of the wiper blade 59 reaches a wipe start position HPw, the controller 10 causes the maintenance part 50 to stop moving. In this embodiment, the wipe start position HPw is set for the nozzle block 31 on the (-X) direction side of the nozzle block row C1. In more detail, as shown in this figure, the wipe start position HPw is set for a most (-X) direction side edge of the nozzle blocks 31. Further, at the wipe start position HPw, the controller 10 lowers the print head 30 from the origin position Ph to the wipe position Pw and lifts the wiper blade 59 corresponding to the nozzle block row C1. The top 591 of the wiper blade 59 is thereby positioned at a position slightly higher than the lower surface of the nozzle block 31, to come into contact with the lower surface of the nozzle block 31. Preparation of the wiping process is thereby completed. At that time, the squeezing block 44 is positioned lower than the top 591 of the wiper blade 59 and the lower surface (nozzle opening plane 31P) of the nozzle block 31 in the height direction Dz.

From this state, the controller 10 moves the maintenance part 50 in the (+X) direction. With this movement, as shown in FIG. 10D, the top 591 of the wiper blade 59 slidingly rubs the lower surface (nozzle opening plane 31P) of the nozzle block 31 and wipes off the ink adhering around the nozzle N (wiping process). Thus, the ink wiped off by the wiper blade 59 drops from the wiper blade 59 onto the bottom plate 571 of the vat 57. Concurrently with this, the cleaning roller 81 holding the cleaning solution is driven-rotated while coming into contact with the top of the seal member 533, to thereby clean and remove the ink adhering to the cap 53 (cap cleaning process). Further, in this cap cleaning process, the lower surface (nozzle opening plane 31P) of the nozzle block 31 does not come into contact with the squeezing block 44 or the seal member 533. The wiping process and the cap cleaning process are performed as the maintenance part 50 moves in the (+X) direction. In this cap cleaning process, the cleaning solution may be ejected from the nozzle 91 toward the cleaning roller 81.

When the wiping process and the cap cleaning process are completed, the controller 10 lifts the print head 30 from the wipe position Pw to the origin position Ph. Subsequently, as shown in FIG. 10E, the squeezing block 44 comes into contact with the surface layer 811 of the cleaning roller 81 as the maintenance part 50 moves in the (+X) direction. Especially, the squeezing block 44 comes into contact with the surface layer 811 below the cored bar 812 and the rotation axis 813 (in other words, below the center of the cleaning roller 81). In a state where the squeezing block 44 is in contact with the cleaning roller 81 thus, the squeezing block 44 moves in the (+X) direction together with the maintenance part 50. The surface layer 811 of the cleaning roller 81 is thereby compressed by pressing of the squeezing block 44, and the ink retained in the surface layer 811 flows out to the squeezing block 44 together with the cleaning solution.

At that time, among the inclined surface 445, the upper surface 442, and the inclined surface 446 provided in the squeezing block 44, the inclined surface 445 positioned at the tip in the (+X) direction (moving direction) first comes into contact with the surface layer 811 of the cleaning roller 81. Then, after the inclined surface 445, the upper surface 442 comes into contact with the surface layer 811 of the cleaning roller 81. After the upper surface 442, the inclined surface 446 comes into contact with the surface layer 811 of the cleaning roller 81.

Further, the squeezing block 44 comes into contact with the cleaning roller 81 while moving in the X direction orthogonal to the rotation axis 813 of the cleaning roller 81. Therefore, the squeezing block 44 adds a torque for rotating the cleaning roller 81 about the rotation axis 813, to the cleaning roller 81. For this reason, following the movement of the squeezing block 44 in the X direction, the cleaning roller 81 (surface layer 811) rotates about the rotation axis 813.

Thus, during a period (contact period) when the squeezing block 44 moves in the X direction while being in contact with the surface layer 811 of the cleaning roller 81, the inclined surface 445, the upper surface 442, and the inclined surface 446 of the squeezing block 44 come into contact with the surface layer 811 in this order. As a result, the ink flows out to the squeezing block 44 from the surface layer 811 of the cleaning roller 81 which rotates, following the squeezing block 44.

Further, when the maintenance part 50 moves in the (+X) direction, the squeezing block 44 goes through the cleaning roller 81, and the top 591 of the wiper blade 59 reaches the cleaning roller 81, the controller 10 stops the movement of the maintenance part 50. Thus, preparation of a wiper cleaning process is completed. In this state, the maintenance part 50 is positioned so that the cleaning roller 81 faces the top 591 of the wiper blade 59 from above.

Then, the controller 10 causes the top 591 of the wiper blade 59 to come into contact with the surface layer 811 of the cleaning roller 81 holding the cleaning solution, to thereby perform cleaning. Specifically, the controller 10 causes the wiper blade 59 to reciprocate by only a very small distance in the Z direction, to thereby clean the top 591 of the wiper blade 59 while shifting a contact position, at which the cleaning roller 81 and the wiper blade 59 contact, in the Z direction (wiper cleaning process). The controller 10 may clean the top 591 of the wiper blade 59 by the cleaning roller 81 while reciprocating the maintenance part 50 by only a very small distance in the X direction. Furthermore, in the wiper cleaning process, the cleaning solution may be ejected from the nozzle 91 toward the cleaning roller 81. When the wiper cleaning process is completed, the controller 10 moves the maintenance part 50 in the (-X) direction, to cause the state to return to the standby state shown in FIG. 2A.

Though the pressurization purge process, the wiping process, the cap cleaning process, and the wiper cleaning process for the nozzle block 31 corresponding to the nozzle block row C1 have been mainly described above, the pressurization purge process, the wiping process, the cap cleaning process, and the wiper cleaning process for the nozzle block 31 corresponding to the nozzle block row C2 are performed in the same manner.

In the printer 1 described above, the surface layer 811 of the cleaning roller 81 (ink absorbing roller) for absorbing ink from the wiper blade 59 (wiper) is rotatable about the rotation axis 813. Then, by moving the squeezing block 44 (squeezing member) in the X direction (moving direction) relative to the surface layer 811 of the cleaning roller 81 while bringing the squeezing block 44 into contact with the surface layer 811 of the cleaning roller 81, ink is squeezed from the surface layer 811 of the cleaning roller 81 by the squeezing block 44. At that time, the X direction is orthogonal to the rotation axis 813 (in other words, the width direction Dy in which the rotation axis 813 is extended) and the surface layer 811 of the cleaning roller 81 rotates, following the squeezing block 44 which relatively moves in the X direction. Therefore, it is possible to suppress an excessive force from being imposed on the surface layer 811 of the cleaning roller 81 by rotating the surface layer 811 of the cleaning roller 81. As a result, it becomes possible to squeeze ink from the ink absorbing roller while suppressing wear of the surface layer 811 of the cleaning roller 81 which absorbs ink from the wiper blade 59.

Further, the squeezing block 44 has the inclined surfaces 445, 446 inclined with respect to the X direction, and contacts the surface layer 811 of the cleaning roller 81 at the inclined surfaces 445, 446. In such a configuration, it is possible to suppress the surface layer 811 of the cleaning roller 81 from being worn out due to the contact with the squeezing block 44.

Further, the squeezing block 44 further has the upper surface 442 extended in the X direction, and the inclined surfaces 445, 446 are so provided as to descend from the ends of the upper surface 442 in the X direction. In such a configuration, by bringing the inclined surfaces 445, 446 provided for the ends of the upper surface 442 of the squeezing block 44 into contact with the surface layer 811 of the cleaning roller 81, it is possible to squeeze ink from the surface layer 811 of the cleaning roller 81 while suppressing the surface layer 811 of the cleaning roller 81 from being worn out.

Further, the squeezing block 44 further has the side surfaces 443, 444 extended downward from the ends of the inclined surfaces 445, 446 which are opposite to the upper surface 442 in the X direction. In such a configuration, it is possible to cause the ink squeezed from the cleaning roller 81 at the inclined surfaces 445, 446 to drop from the side surfaces 443, 444, respectively, to be discarded.

Further, the squeezing block 44 further has the ink guide protrusion 49 (first guide) extended downward from the side surface 444 to be tapered downward. In such a configuration, it is possible to concentrate the position, at which the ink drops from the side surface 444, to the ink guide protrusion 49 and it thereby becomes easier to control a flow of the discarded ink. In other words, in the above-described exemplary case, it is controlled that the ink can drop onto the bottom plate 676 of the ink guide receiver 675.

Further, the vat 57 (collection tray) for receiving the ink dropping from the ink guide protrusion 49 of the squeezing block 44 is provided. In such a configuration, it is possible to suppress the discarded ink from spreading in the printer 1.

Further, the ink guide drains 47, 48 (second guide) for guiding the ink dropping from the side surface 443 of the squeezing block 44 to the opening 484 (collection position) located away from the wiper blade 59 are provided. Then, the vat 57 (collection tray) receives the ink guided to the opening 484. In such a configuration, it is possible to suppress the discarded ink from spreading in the printer 1.

Further, the squeezing block 44 has the lower surface 441 which is so extended in parallel to the upper surface 442 in the X direction as to face the upper surface 442 from below. The recessed portions 451, 453 are provided between the lower ends of the side surfaces 443, 444 and the lower surface 441 in the X direction. The recessed portions 451, 453 are recessed upward from the lower ends of the side surfaces 443, 444 and the lower surface 441, respectively. In such a configuration, it is possible to dam up the ink going around from the side surfaces 443, 444 of the squeezing block 44 to the lower surface 441 thereof by the recessed portions 451, 453, to thereby suppress the ink from dropping from the lower surface 441 of the squeezing block 44. As a result, it is possible to effectively utilize the space below the squeezing block 44 for arrangement of other members while suppressing the ink from adhering to the other members.

Further, the lifting and lowering mechanism 58 (wiper lifting and lowering mechanism) for lifting and lowering the wiper blade 59 is provided. At least part (the shaft 61, the linear bushings 62, 63, the lifting and lowering frame 64, the spring 65, and the eccentric cam 66) of the lifting and lowering mechanism 58 is so disposed as to face the squeezing block 44 from below. In such a configuration, it is possible to effectively utilize the space below the squeezing block 44 for arrangement of the lifting and lowering mechanism 58.

Further, the cover plate 43 (cover member) disposed between the squeezing block 44 and the lifting and lowering mechanism 58 in the Z direction is provided. This cover plate 43 overlaps at least part (the shaft 61, the linear bushings 62, 63, the spring 65, and the eccentric cam 66) of the lifting and lowering mechanism 58 when viewed in the Z direction. In such a configuration, the cover plate 43 makes it possible to suppress the ink dropping from the squeezing block 44 from adhering to the lifting and lowering mechanism 58.

Further, the screw 464 for fastening the squeezing block 44 and the cover plate 43 to each other and the seal washer 463 into which the screw 464 is inserted are provided. The squeezing block 44 has the counterbore 461 in which the seal washer 463 is disposed and the insertion hole 462 provided corresponding to the counterbore 461. The cover plate 43 has the screw hole 431 facing the insertion hole 462. The screw 464 is screwed into the screw hole 431 while being inserted into the seal washer 463 and the insertion hole 462. Then, the seal washer 463 seals the gap between the insertion hole 462 and the screw 464. In such a configuration, the seal washer 463 makes it possible to suppress the ink from dropping from the gap between the screw 464 and the insertion hole 462 for the screw and adhering to the lifting and lowering mechanism 58.

Further, the vat 57 (collection tray) for receiving the ink dropping from the squeezing block 44 is provided. In such a configuration, it is possible to suppress the discarded ink from spreading in the printer 1.

Further, the vat 57 receives the ink dropping from the wiper blade 59. In such a configuration, the squeezing block 44 and the wiper blade 59 can share the vat 57 and it is thereby possible to reduce the number of components in the printer 1.

In the above-described embodiment, the nozzle opening plane 31P corresponds to one example of a "nozzle opening plane" of the present disclosure, the print head 30 corresponds to one example of an "inkjet head" of the present disclosure, the wiper blade 59 corresponds to one example of a "wiper" of the present disclosure, the rotation axis 813 corresponds to one example of a "rotation axis" of the present disclosure, the cleaning roller 81 corresponds to one example of an "ink absorbing roller" of the present disclosure, the squeezing block 44 corresponds to one example of a "squeezing member" of the present disclosure, the X direction corresponds to one example of a "moving direction" of the present disclosure, the motor 753 corresponds to one example of a "moving mechanism" of the present disclosure, the printer 1 corresponds to one example of a "printer" of the present disclosure, the inclined surface 445 or the inclined surface 446 corresponds to one example of an "inclined surface" of the present disclosure, the upper surface 442 corresponds to one example of an "upper surface" of the present disclosure, the side surface 443 or the side surface 444 corresponds to one example of a "side surface" of the present disclosure, the ink guide protrusion 49 corresponds to one example of a "first guide" of the present disclosure, the vat 57 corresponds to one example of a "collection tray" of the present disclosure, the ink guide drain 47 or the ink guide drain 48 corresponds to one example of a "second guide" of the present disclosure, the lower surface 441 corresponds to one example of a "lower surface" of the present disclosure, the recessed portion 451 or the recessed portion 453 corresponds to one example of a "recessed portion" of the present disclosure, the lifting and lowering mechanism 58 corresponds to one example of a "wiper lifting and lowering mechanism" of the present disclosure, the cover plate 43 corresponds to one example of a "cover member" of the present disclosure, the screw 464 corresponds to one example of a "screw" of the present disclosure, the seal washer 463 corresponds to one example of a "seal washer" of the present disclosure, the counterbore 461 corresponds to one example of a "counterbore" of the present disclosure, the insertion hole 462 corresponds to one example of an "insertion hole" of the present disclosure, and the screw hole 431 corresponds to one example of a "screw hole" of the present disclosure,

Further, the present disclosure is not limited to the above-described embodiment, but numerous modifications and variations other than those described above can be devised without departing from the scope of the disclosure. For example, the direction in which the squeezing block 44 is moved in order to squeeze the ink from the cleaning roller 81 by the squeezing block 44 is not limited to the (+X) direction but may be the (-X) direction.

Specifically, as shown in FIG. 10F, from a state where the squeezing block 44 is positioned on the (+X) direction side (the upstream side in the moving direction) relative to the cleaning roller 81, the squeezing block 44 starts moving in the (-X) direction (moving direction). Then, like in the above-described case, the squeezing block 44 comes into contact with the surface layer 811 of the cleaning roller 81 below the center of the cleaning roller 81. Thus, in the state where the squeezing block 44 is in contact with the cleaning roller 81, the squeezing block 44 moves in the (-X) direction together with the maintenance part 50. The surface layer 811 of the cleaning roller 81 is thereby compressed by pressing of the squeezing block 44, and the ink retained in the surface layer 811 flows out to the squeezing block 44 together with the cleaning solution.

At that time, among the inclined surface 446, the upper surface 442, and the inclined surface 445 provided in the squeezing block 44, the inclined surface 446 positioned at the tip in the (-X) direction (moving direction) first comes into contact with the surface layer 811 of the cleaning roller 81. Then, after the inclined surface 446, the upper surface 442 comes into contact with the surface layer 811 of the cleaning roller 81, and after the upper surface 442, the inclined surface 445 comes into contact with the surface layer 811 of the cleaning roller 81.

Thus, during the period (contact period) in which the squeezing block 44 moves in the X direction while being in contact with the surface layer 811 of the cleaning roller 81, the inclined surface 446, the upper surface 442, and the inclined surface 445 of the squeezing block 44 come into contact with the surface layer 811 in this order. As a result, the ink flows out to the squeezing block 44 from the surface layer 811 of the cleaning roller 81 which rotates, following the squeezing block 44.

Further, during the period (contact period) in which the surface layer 811 of the cleaning roller 81 is contact with the squeezing block 44, the cleaning solution may be supplied to the surface layer 811 of the cleaning roller 81 from the nozzle 91 of the cleaning solution supplier 90. This supply of the cleaning solution may be performed throughout the whole contact period or may be performed during part of the contact period.

Thus, the squeezing block 44 squeezes the ink from the surface layer 811 of the cleaning roller 81. At that time, the X direction is orthogonal to the rotation axis 813 (in other words, the width direction Dy in which the rotation axis 813 is extended) and the surface layer 811 of the cleaning roller 81 rotates, following the squeezing block 44 which relatively moves in the X direction. Therefore, it is possible to suppress an excessive force from being imposed on the surface layer 811 of the cleaning roller 81 by rotating the surface layer 811 of the cleaning roller 81. As a result, it becomes possible to squeeze ink from the ink absorbing roller while suppressing wear of the surface layer 811 of the cleaning roller 81 which absorbs the ink from the wiper blade 59.

Further, the position of the ink guide protrusion 49 may be changed in the width direction Dy. Specifically, the ink guide protrusion 49 may not face the bottom plate 676 of the ink guide receiver 675. For example, the ink guide protrusion 49 may be so arranged as to face the bottom plate 571 of the vat 57 at a position away from the bottom plate 676 in the width direction Dy.

Further, it is not indispensable to provide the inclined surface 445 or the inclined surface 446 in the squeezing block 44. Therefore, one of these inclined surfaces or both the inclined surfaces may not be provided.

Further, a specific configuration to guide the ink which has flowed out to the squeezing block 44, to the vat 57, is not limited to the above-described ink guide drains 47 and 48 and the ink guide protrusion 49. Therefore, for example, without providing the ink guide protrusion 49, the ink may be dropped from the side surface 444 of the squeezing block 44 to the vat 57.

Further, in order to move the squeezing block 44 relative to the cleaning roller 81, it is not indispensable to drive the squeezing block 44, but the cleaning roller 81 may be driven.

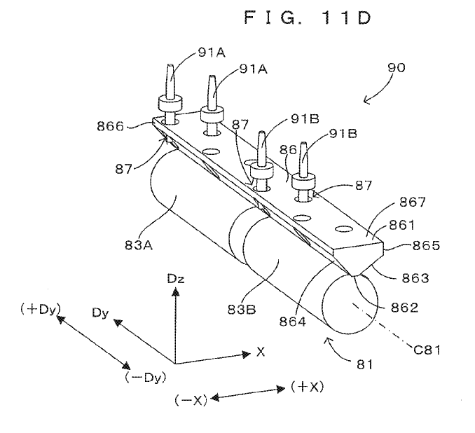

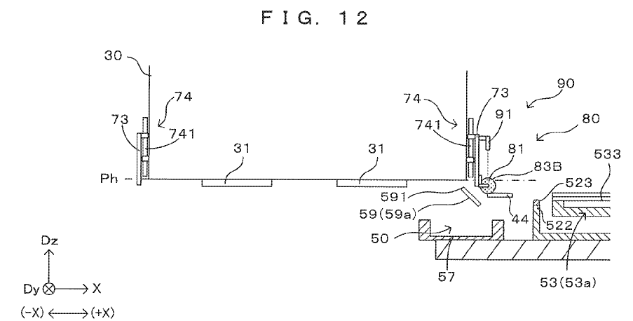

Further, the cleaning roller 81 may be formed as shown in the following variation. FIGS. 11A-11D are views each showing a variation of the cleaning part. In FIG. 11A and the like, description will be made by using a (+Dy) side and a (-Dy) side in the width direction Dy. Herein, the (+Dy) side and the (-Dy) side face opposite to each other. Hereinafter, description will be made, centering on a difference from the above-described embodiment, and description on common points will be omitted as appropriate.

The cleaning roller 81 has two surface layer rollers 83A, 83B arranged in the width direction Dy. In the width direction Dy, the surface layer roller 83A and the surface layer roller 83B are separated from each other and a gap is provided between the surface layer roller 83A and the surface layer roller 83B. The surface layer rollers 83A, 83B each have a cylindrical shape extended in the width direction Dy. In other words, a peripheral surface of each of the surface layer rollers 83A, 83B has a cylindrical shape about a center line in parallel to the width direction Dy. Each of the surface layer rollers 83A, 83B is a sponge, which is a porous member, and has liquid retention to retain a liquid such as a cleaning solution, ink, or the like and elasticity. An insertion hole extended in parallel to the width direction Dy penetrates each of the surface layer rollers 83A, 83B. The cored bar 812 of the cleaning roller 81 is inserted into the insertion hole in the width direction Dy to support the surface layer rollers 83A, 83B. Further, the rotation axis 813 is provided coaxially with the center of the cored bar 812.

Both ends of the rotation axis 813 are supported rotatably by a support bracket 84. Therefore, the peripheral surfaces of the surface layer rollers 83A, 83B rotate about the rotation axis 813. The support bracket 84 has a base plate 841 in parallel to the width direction Dy and the height direction Dz. To a side surface of the head support side plate 73 in the (+X) direction among the pair of head support side plates 73 shown in FIG. 6, the base plate 841 is attached with a screw. The support bracket 84 has a top plate 843 protruding toward the X direction from a lower end portion of the base plate 841 in the height direction Dz. Further, the support bracket 84 has a side plate 844 protruding downward in the height direction Dz from an end of the top plate 843 on the (-Dy) side and a side plate 845 protruding upward in the height direction Dz from an end of the top plate 843 on the (+Dy) side.

The support bracket 84 has a latch mechanism 85 attached to the side plate 845. The latch mechanism 85 has an L-shaped bracket 851. The L-shaped bracket 851 has a plate 851z provided in the height direction Dz and a plate 851y provided on the (+Dy) side from an upper end of the plate 851z in the height direction Dz, and the plate 851z is attached to the side plate 845 with a screw. Further, the latch mechanism 85 has an L-shaped bracket 853 facing the L-shaped bracket 851 from the (+Dy) side. The L-shaped bracket 853 has a plate 853z extended in the height direction Dz and a plate 853y provided on the (-Dy) side from an upper end of the plate 853z in the height direction Dz. The plate 851y and the plate 853y are coupled to each other, and the plate 851z and the plate 853z face each other with a gap therebetween in the width direction Dy.

The support bracket 84 has rods 854t, 854b each extending in the width direction Dy. In the width direction Dy, each of the rods 854t, 854b is disposed between the plate 851z and the plate 853z, and both end portions of each of the rods 854t, 854b are supported by the plate 851z and the plate 853z. The rod 854t is positioned above the rod 854b.

The latch mechanism 85 has a movable fitting 855 provided between the plate 851z and the plate 853z in the width direction Dy. The movable fitting 855 has a top plate 855t provided in the height direction Dz and a bottom plate 855b provided in the height direction Dz below the top plate 855t. The top plate 855t is positioned on the (-Dy) side relative to the bottom plate 855b. Further, the movable fitting 855 has a link plate 855l provided in the width direction Dy, for connecting a lower end of the top plate 855t and an upper end of the bottom plate 855b to each other. The top plate 855t is provided with an insertion hole penetrating it in the width direction Dy, and the rod 854t is inserted into the insertion hole of the top plate 855t. The bottom plate 855b is provided with an insertion hole penetrating it in the width direction Dy, and the rod 854b is inserted into the insertion hole of the bottom plate 855b. Therefore, the movable fitting 855 is movable in the width direction Dy while being guided by the rods 854t, 854b.

The latch mechanism 85 has a spring 856 provided between the top plate 855t and the plate 853z. The spring 856 externally fits around the rod 854t and urges the movable fitting 855 toward the (-Dy) direction with respect to the L-shaped bracket 853. The bottom plate 855b is provided with a fitting hole penetrating it in the width direction Dy and an end portion of the rotation axis 813 on the (+Dy) side fits in the fitting hole of the bottom plate 855b. Further, the latch mechanism 85 has a knob 857 provided downward from the link plate 855l of the movable fitting 855 in the height direction Dz.

Thus, both the ends of the cleaning roller 81 (rotation axis 813) are supported rotatably by the side plate 844 and the bottom plate 855b. When an operator moves the knob 857 toward the (+Dy) side against an urging force of the spring 856, the bottom plate 855b moves toward the (+Dy) side to be out of the rotation axis 813 of the cleaning roller 81. As a result, it is possible to remove the cleaning roller 81 from the support bracket 84.

Further, the support bracket 84 supports the nozzles 91A, 91B for supplying the cleaning solution to the surface layer rollers 83A, 83B, a cleaning block 86 coming into contact with the surface layer rollers 83A, 83B from above in the height direction Dz, and the like. The nozzles 91A, 91B are provided above away from the surface layer rollers 83A, 83B in the height direction Dz. The cleaning block 86 is supported by the support bracket 84, movably in the height direction Dz.

FIG. 11D shows a positional relationship among the nozzles 91A and 91B, the cleaning block 86, and the cleaning roller 81 in the cleaning solution supplier. FIG. 11D shows a rotation center line C81 of the cleaning roller 81. In other words, the cleaning roller 81 (the surface layer rollers 83A, 83B) rotates about the rotation center line C81.

The cleaning solution supplier 90 has the plurality of nozzles 91A, 91B arranged in a staggered manner in the Y direction. Among these nozzles, two nozzles 91A face the surface layer roller 83A from above in the height direction Dz and two nozzles 91B face the surface layer roller 83B from above in the height direction Dz. The nozzles 91A, 91B eject the cleaning solution downward in the height direction Dz. The cleaning solution ejected from the nozzles 91A is supplied to the surface layer roller 83A and the cleaning solution ejected from the nozzles 91B is supplied to the surface layer roller 83B. The cleaning solution has, for example, a composition obtained by removing a pigment from ink.

In the width direction Dy, the two nozzles 91A are arranged unevenly on the (+Dy) side of the surface layer roller 83A and arranged unevenly on the (+Dy) side of the two surface layer rollers 83B. In other words, the nozzle 91A is positioned on the (+Dy) side relative to the center of the surface layer roller 83A in the width direction Dy to face the surface layer roller 83A, and the nozzle 91B is positioned on the (+Dy) side relative to the center of the surface layer roller 83B in the width direction Dy to face the surface layer roller 83B.

The cleaning block 86 has a block main body 861 which is long in the width direction Dy. The block main body 861 is formed of, for example, a resin. At a lower end of the block main body 861 (an end on the lower side in the height direction Dz), provided is a cleaning surface 862 facing the cleaning roller 81 from above. The cleaning surface 862 is a plane in parallel to the X direction and the width direction Dy. In the width direction Dy, the cleaning surface 862 is longer than the cleaning roller 81, and the cleaning roller 81 is positioned between both ends of the block main body 861. This cleaning surface 862 comes into contact with the cleaning roller 81 from above in the height direction Dz.

Further, the block main body 861 has inclined surfaces 863, 864 on both ends of the cleaning surface 862 in the X direction. The inclined surface 863 is a plane provided on the (+X) direction side of the cleaning surface 862 and inclined upward in the height direction Dz as it goes toward the (+X) direction. The inclined surface 864 is a plane provided on the (-X) direction side of the cleaning surface 862 and inclined upward in the height direction Dz as it goes toward the (-X) direction. Furthermore, the block main body 861 has a side surface 865 extended upward in the height direction Dz from an upper end of the inclined surface 863 and a side surface 866 extended upward in the height direction Dz from an upper end of the inclined surface 864. The side surface 865 and the side surface 866 are planes in parallel to the width direction Dy and the height direction Dz. Further, the block main body 861 has an upper surface 867 provided between respective upper ends of the side surface 865 and the side surface 866. The upper surface 867 is a plane in parallel to the X direction and the width direction Dy.

The cleaning block 86 has a plurality of nozzle insertion holes 87 arranged in a staggered manner in the width direction Dy. The nozzle insertion hole 87 is provided to penetrate the block main body 861 in the height direction Dz, and the nozzle 91A or 91B corresponding to the nozzle insertion hole 87 is inserted into the nozzle insertion hole 87. Among the plurality of nozzle insertion holes 87, the nozzle insertion hole 87 on the (+X) direction side opens downward in the height direction Dz in the inclined surface 863. Therefore, the cleaning solution ejected from the nozzle 91A or 91B inserted in the nozzle insertion hole 87 on the (+X) direction side is ejected downward in the height direction Dz from the nozzle insertion hole 87 which opens in the inclined surface 863. Among the plurality of nozzle insertion holes 87, the nozzle insertion hole 87 on the (-X) direction side opens downward in the height direction Dz in the inclined surface 864. Therefore, the cleaning solution ejected from the nozzle 91A or 91B inserted in the nozzle insertion hole 87 on the (-X) direction side is ejected downward in the height direction Dz from the nozzle insertion hole 87 which opens in the inclined surface 864.

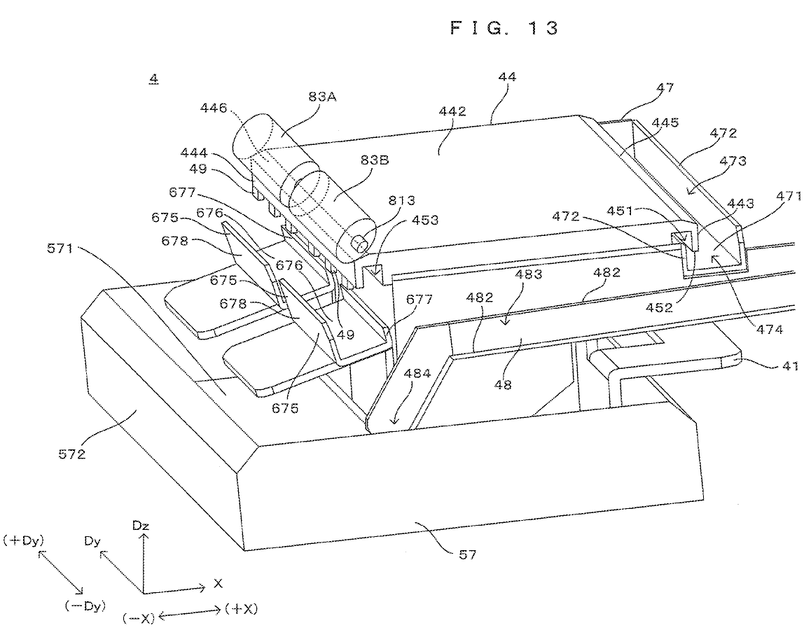

Maintenance can be performed also on this cleaning roller 81 by an operation like that shown in FIGS. 10A-10F. At that time, instead of the operation shown in FIG. 10E, an operation shown in FIGS. 12-14 may be performed. FIGS. 12-14 are views each schematically showing an operation of the maintenance part and the cleaning part.

When the wiping process and the cap cleaning process are completed, the controller 10 lifts the print head 30 from the wipe position Pw to the origin position Ph. Subsequently, as shown in FIG. 12, with the movement of the maintenance part 50 toward the (+X) direction, the squeezing block 44 comes into contact with the surface layer rollers 83A, 83B of the cleaning roller 81. Especially, below the cored bar 812 and the rotation axis 813 (in other words, below the center of the cleaning roller 81), the squeezing block 44 comes into contact with the surface layer rollers 83A, 83B. Thus, in the state where the squeezing block 44 is in contact with the surface layer rollers 83A, 83B, the squeezing block 44 moves in the (+X) direction together with the maintenance part 50. The surface layer rollers 83A, 83B of the cleaning roller 81 are thereby compressed by pressing of the squeezing block 44, and the ink retained in the surface layer rollers 83A, 83B flows out to the squeezing block 44 together with the cleaning solution.

At that time, the squeezing block 44 comes into contact with the cleaning roller 81 while moving in the X direction orthogonal to the rotation axis 813 of the cleaning roller 81. Therefore, the squeezing block 44 adds a torque, which rotates the cleaning roller 81 about the rotation axis 813, to the cleaning roller 81. For this reason, following the movement of the squeezing block 44 in the X direction, the surface layer rollers 83A, 83B of the cleaning roller 81 rotate about the rotation axis 813.

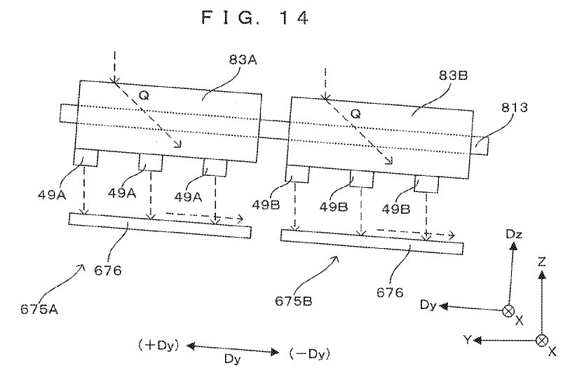

Especially, the surface layer rollers 83A, 83B are stopped with respect to the inclined surface 446 in the state where the surface layer rollers 83A, 83B come into contact with the inclined surface 446 positioned at the end in the (-X) direction (moving direction) among the inclined surface 445, the upper surface 442, and the inclined surface 446 provided in the squeezing block 44, as shown in FIG. 13. Then, the cleaning solution is supplied to the surface layer rollers 83A, 83B from the nozzles 91A, 91B. This is mainly performed for the purpose of cleaning the ink guide receiver 675 with the cleaning solution (receiver cleaning operation). Further, in the receiver cleaning operation, after the surface layer rollers 83A and 83B are stopped with respect to the inclined surface 446, the surface layer rollers 83A and 83B may be reciprocated by a very small width in the X direction.

In the squeezing block 44 shown in FIGS. 13 and 14, the plurality of (six) ink guide protrusions 49 are arranged in the width direction Dy at intervals. Each ink guide protrusion 49 protrudes downward in the height direction Dz from the side surface 444 (in other words, the extended surface 454 (FIG. 9A)) of the squeezing block 44. The ink guide protrusion 49 has a rectangular block shape as viewed from the X direction. The shape of the ink guide protrusion 49 is not limited to this example but may have a shape pointed downward like in the above-described exemplary case.

As shown in FIG. 14, the plurality of ink guide protrusions 49 include M1 (three) ink guide protrusions 49A on the (+Dy) side and M2 (three) ink guide protrusions 49B on the (-Dy) side. Further, in FIG. 14, among the two ink guide receivers 675, the ink guide receiver 675 on the (+Dy) side is represented by reference sign 675A, and the ink guide receiver 675 on the (-Dy) side is represented by reference sign 675B. The M1 ink guide protrusions 49A face the bottom plate 676 of the ink guide receiver 675A from above in the height direction Dz and the M2 ink guide protrusions 49B face the bottom plate 676 of the ink guide receiver 675B from above in the height direction Dz.

In the receiver cleaning operation, in a plan view as seen from above in the height direction Dz, the surface layer roller 83A overlaps the M1 ink guide protrusions 49A and the M1 ink guide protrusions 49A are hidden by the surface layer roller 83A. Similarly, in this plan view, the surface layer roller 83B overlaps the M2 ink guide protrusions 49B and the M2 ink guide protrusions 49B are hidden by the surface layer roller 83B. Further, in this plan view, the surface layer roller 83A overlaps the bottom plate 676 of the ink guide receiver 675A and the surface layer roller 83B overlaps the bottom plate 676 of the ink guide receiver 675B.

Further, in the receiver cleaning operation, a cleaning solution Q is supplied to the surface layer roller 83A in contact with the inclined surface 446 from the nozzle 91A, and the cleaning solution Q is supplied to the surface layer roller 83B in contact with the inclined surface 446 from the nozzle 91B. Furthermore, the ink collection unit 4 is inclined from the (+Dy) side toward the (-Dy) side, and the surface layer rollers 83A, 83B and the bottom plates 676 of the ink guide receivers 675A, 675B are also inclined. Therefore, the cleaning solution Q supplied to the surface layer rollers 83A, 83B proceeds in such a manner as to spread from the (+Dy) side to the (-Dy) side in the surface layer rollers 83A, 83B.

The cleaning solution Q which has flowed out from the surface layer roller 83A to reach the ink guide protrusion 49A goes along the ink guide protrusion 49A and drops onto the bottom plate 676 of the ink guide receiver 675A. Since the bottom plate 676 is inclined as described above, the cleaning solution Q dropping onto the bottom plate 676 goes toward the (-Dy) side along the bottom plate 676 and drops from the end of the bottom plate 676 on the (-Dy) side onto the bottom plate 571. Thus, the bottom plate 676 of the ink guide receiver 675A is cleaned with the cleaning solution Q.

The cleaning solution Q which has flowed out from the surface layer roller 83B to reach the ink guide protrusion 49B goes along the ink guide protrusion 49B and drops onto the bottom plate 676 of the ink guide receiver 675B. Since the bottom plate 676 is inclined as described above, the cleaning solution Q dropping onto the bottom plate 676 goes toward the (-Dy) side along the bottom plate 676 and drops from the end of the bottom plate 676 on the (-Dy) side onto the bottom plate 571. Thus, the bottom plate 676 of the ink guide receiver 675B is cleaned with the cleaning solution Q.

Further, to the bottom plates 676 of the ink guide receivers 675A, 675B, the ink dropping from the wiper blade 59 adheres. This ink is sometimes dried and solidified on the bottom plate 676. In contrast to this, by guiding the cleaning solution Q which has flowed out from the surface layer rollers 83A, 83B of the cleaning roller 81 onto the respective bottom plates 676 by the ink guide protrusions 49A, 49B, it becomes possible to wash away the ink solidified on the bottom plates 676.

Then, after this receiver cleaning operation has been performed for a predetermined period, the maintenance part 50 moves in the (+X) direction like in the above-described exemplary case. Then, when the squeezing block 44 goes through the cleaning roller 81 and the top 591 of the wiper blade 59 reaches the cleaning roller 81, the controller 10 stops the movement of the maintenance part 50. Subsequently, the wiper cleaning process starts.

In the variation described above, the plurality of ink guide protrusions 49 (first guides) are provided in the width direction Dy which is the extending direction of the rotation axis 813. In such a configuration, it is possible to control a drop position of the ink by guiding the ink by each ink guide protrusion 49.

Further, the cleaning roller 81 (ink absorbing roller) includes the two surface layer rollers 83A, 83B arranged in the width direction Dy. In such a configuration, the cleaning solution Q can be supplied to each of the two surface layer rollers 83A, 83b. For this reason, it is possible to suppress variation in the amount of cleaning solution Q to be supplied in the cleaning roller 81.

Further, the two ink guide receivers 675A, 675B (ink receivers) are provided corresponding to the two surface layer rollers 83A, 83B. The ink squeezed from the surface layer roller 83A (one split roller) by the squeezing block 44 (squeezing member) drops on the ink guide receiver 675A (one ink receiver). The ink squeezed from the surface layer roller 83B (the other split roller) by the squeezing block 44 drops on the ink guide receiver 675B (the other ink receiver). In such a configuration, the two ink guide receivers 675A, 675B can accurately receive the cleaning solution Q dropping from the two surface layer rollers 83A, 83B.

Further, the squeezing block 44 has the M1 (M1 is an integer not less than 1) ink guide protrusions 49A protruding downward and the M2 (M2 is an integer not less than 1) ink guide protrusions 49B protruding downward. The ink squeezed from the surface layer roller 83A by the squeezing block 44 drops downward along the M1 ink guide protrusions 49A. The ink squeezed from the surface layer roller 83B (the other split roller) by the squeezing block 44 drops downward along the M2 ink guide protrusions 49B. In such a configuration, the drop position of the ink squeezed from the surface layer roller 83A by the squeezing block 44 can be controlled by the M1 ink guide protrusions 49A and the drop position of the ink squeezed from the surface layer roller 83B by the squeezing block 44 can be controlled by the M2 ink guide protrusions 49B.

Further, M1 and M2 may be each single or plural. Therefore, M1 may be not less than 2, and M2 may be not less than 2. Further, M1 and M2 may be the same as or different from each other.

Further, the nozzles 91A, 91B (two cleaning solution suppliers) for supplying the cleaning solution Q to the cleaning roller 81 are provided. The nozzle 91A (one cleaning solution supplier) supplies the cleaning solution Q to the surface layer roller 83A, and the nozzle 91B (the other cleaning solution supplier) supplies the cleaning solution Q to the surface layer roller 83B. In such a configuration, by the nozzles 91A, 91B which are individually provided for the two surface layer rollers 83a, 83B, respectively, the cleaning solution Q can be accurately supplied to each of the surface layer rollers 83A, 83B.

Further, in the printer 1 in which the extending direction (width direction Dy) of the cleaning roller 81 is inclined with respect to the horizontal direction, such a configuration is suitable. Specifically, in a case where the cleaning roller 81 is not divided, when the extending direction (width direction Dy) of the cleaning roller 81 is inclined, the cleaning solution Q unevenly pools in the end portion on the lower side of the cleaning roller 81. In contrast to this, when the cleaning roller 81 includes two surface layer rollers 83A and 83B, it is possible to suppress the cleaning solution Q from unevenly pooling.

Further, a gap is provided between the two surface layer rollers 83A, 83B. It is thereby possible to suppress the cleaning solution Q supplied to the upper surface layer roller 83A from going down to the lower surface layer roller 83b and possible to suppress the cleaning solution Q from unevenly pooling.

Further, the squeezing block 44 has M1 ink guide protrusions 49A protruding downward and M2 ink guide protrusions 49B protruding downward. The ink squeezed from the surface layer roller 83A by the squeezing block 44 drops downward along the M1 ink guide protrusions 49A together with the cleaning solution Q. The ink squeezed from the surface layer roller 83B by the squeezing block 44 drops downward along the M2 ink guide protrusions 49B together with the cleaning solution Q. In such a configuration, it is possible to control the drop position of ink by guiding the ink by each of the ink guide protrusions 49A, 49B.

Further, the width direction Dy descends from the (+Dy) side (one side) toward the (-Dy) side (the other side). At least one ink guide protrusion 49A (the ink guide protrusion 49A at the end on the (+Dy) side) among the M1 ink guide protrusions 49A is positioned on the (+Dy) side (upper side) relative to the center of the surface layer roller 83A. At least one ink guide protrusion 49B among the M2 ink guide protrusions 49B is positioned on the (+Dy) side (upper side) relative to the center of the surface layer roller 83B. In such a configuration, it is possible to suppress the cleaning solution Q from unevenly pooling on the lower side of each of the surface layer rollers 83A, 83B.

Further, the two ink guide receivers 675A, 675B corresponding to the two surface layer rollers 83A, 83B are provided. The ink squeezed from the surface layer roller 83A by the squeezing block 44 drops along the M1 ink guide protrusions 49A onto the ink guide receiver 675A together with the cleaning solution Q. The ink squeezed from the surface layer roller 83B by the squeezing block 44 drops along the M2 ink guide protrusions 49B onto the ink guide receiver 675B together with the cleaning solution Q. In such a configuration, it is possible to accurately drop the ink onto the ink guide receiver 675A by the M1 ink guide protrusions 49A and accurately drop the ink onto the ink guide receiver 675B by the M2 ink guide protrusions 49B.

Further, the receiver cleaning operation is performed. In this receiver cleaning operation, the controller 10 controls the motor 753 (moving mechanism) to bring the two surface layer rollers 83A and 83B into contact with the inclined surface 446 (end portion) of the squeezing block 44. Thus, when viewed from above in the height direction Dz, the controller 10 causes the surface layer roller 83A to overlap the M1 ink guide protrusions 49A from above and causes the surface layer roller 83B to overlap the M2 ink guide protrusions 49B from above. Then, the controller 10 supplies the cleaning solution Q to the surface layer roller 83A from the nozzle 91A, to thereby drop the cleaning solution Q from the M1 ink guide protrusions 49A onto the ink guide receiver 675A. Furthermore, the controller 10 supplies the cleaning solution Q to the surface layer roller 83B from the nozzle 91B, to thereby drop the cleaning solution Q from the M2 ink guide protrusions 49B onto the ink guide receiver 675B. By this receiver cleaning operation, it is possible to clean the ink guide receivers 675A and 675B with the cleaning solution Q, to thereby wash away the ink and the like stuck to the ink guide receivers 675A and 675B.

Further, in this example shown herein, the case where the ink collection unit 4 is inclined has been described. It is not indispensable, however, for the ink collection unit 4 to be inclined, and the ink collection unit 4 may be disposed horizontally.

The present disclosure is applicable to a general maintenance technique of an ink absorbing roller for absorbing ink from a wiper which wipes off the ink from a nozzle opening plane of an inkjet head.

As described above, the printer may be configured so that the squeezing member has an inclined surface which is inclined with respect to the moving direction and the inclined surface of the squeezing member contacts the ink absorbing roller. In such a configuration, it is possible to suppress the ink absorbing roller from being worn out due to the contact with the squeezing member.

The printer may be configured so that the squeezing member further has an upper surface extended in the moving direction, and the inclined surface is so provided as to descend from an end of the upper surface in the moving direction. In such a configuration, by bringing the inclined surface provided for the end of the upper surface of the squeezing member into contact with the ink absorbing roller, it is possible to squeeze ink from the ink absorbing roller while suppressing the ink absorbing roller from being worn out.

The printer may be configured so that the squeezing member further has a side surface extended downward from an end of the inclined surface which is opposite to the upper surface in the moving direction. In such a configuration, it is possible to cause ink squeezed from the ink absorbing roller on the inclined surface to drop from the side surface to be discarded.

The printer may be configured so that the squeezing member further has a first guide tapered downward from the side surface. In such a configuration, it is possible to concentrate a position, at which ink drops from the side surface, to the first guide and it thereby becomes easier to control a flow of the discarded ink.

The printer may further comprise: a collection tray receiving ink dropping from the first guide of the squeezing member. In such a configuration, it is possible to suppress the discarded ink from spreading in the printer.

The printer may further comprise: a collection tray, and the squeezing member further having a second guide guiding ink dropping from the side surface of the squeezing member to a collection position away from the wiper, wherein the collection tray receives ink which is guided to the collection position. In such a configuration, it is possible to suppress the discarded ink from spreading in the printer.

The printer may be configured so that the squeezing member further has a lower surface which is so extended in parallel to the upper surface in the moving direction as to face the upper surface from below and a recessed portion provided between a lower end of the side surface and the lower surface in the moving direction, and the recessed portion is recessed upward from each of the lower end of the side surface, and the lower surface. In such a configuration, it is possible to dam up ink going around from the side surface of the squeezing member to the lower surface thereof by the recessed portion, to thereby suppress the ink from dropping from the lower surface of the squeezing member. As a result, it is possible to effectively utilize a space below the squeezing member for arrangement of other members while suppressing the ink from adhering to the other members.

The printer may further comprise: a wiper lifting and lowering mechanism configured to lift and lower the wiper, wherein the wiper lifting and lowering mechanism is so disposed as to face the squeezing member from below. In such a configuration, it is possible to effectively utilize a space below the squeezing member for arrangement of the wiper lifting and lowering mechanism.

The printer may further comprise: a cover member disposed between the squeezing member and the wiper lifting and lowering mechanism in a vertical direction, wherein the cover member overlaps at least part of the wiper lifting and lowering mechanism when viewed in a vertical direction. In such a configuration, cover member makes it possible to suppress the ink dropping from the squeezing member from adhering to the wiper lifting and lowering mechanism.

The printer may further comprise: a screw fastening the squeezing member and the cover member to each other; and a seal washer into which the screw is inserted, wherein the squeezing member has a counterbore in which the seal washer is disposed and an insertion hole provided for the counterbore, the cover member has a screw hole facing the insertion hole, the screw is screwed into the screw hole while being inserted into the seal washer and the insertion hole, and the seal washer seals a gap between the insertion hole and the screw. In such a configuration, the seal washer makes it possible to suppress the ink from dropping from the gap between the screw and the insertion hole for the screw to adhere to the wiper lifting and lowering mechanism.

The printer may further comprises: a collection tray receiving ink dropping from the squeezing member. In such a configuration, it is possible to suppress the discarded ink from spreading in the printer.

The printer may be configured so that the collection tray receives ink dropping from the wiper. In such a configuration, the squeezing member and the wiper can share the collection tray and it is thereby possible to reduce the number of components in the printer.

The printer may be configured so that a plurality of first guides is provided in an extending direction of the rotation axis. In such a configuration, it is possible to control a drop position of ink by guiding the ink by each first guide.

The printer may be configured so that the ink absorbing roller includes two split rollers disposed in an extending direction of the rotation axis. In such a configuration, the cleaning solution can be supplied to each of the two split rollers. For this reason, it is possible to suppress variation in the amount of cleaning solution to be supplied in the ink absorbing roller.

The printer may further comprise: two ink receivers provided corresponding to the two split rollers, wherein ink squeezed by the squeezing member from one split roller among the two split rollers drops onto one ink receiver among the two ink receivers, and ink squeezed by the squeezing member from the other split roller among the two split rollers drops onto the other ink receiver among the two ink receivers. In such a configuration, the two ink receivers can accurately receive the cleaning solution dropping from the two split rollers.

The printer may be configured so that the squeezing member has M1 first guide protruding downward and M2 first guide protruding downward, M1 being an integer not less than 1, M2 being an integer not less than 1, ink squeezed by the squeezing member from the one split roller among the two split rollers drops downward along the M1 first guide, and ink squeezed by the squeezing member from the other split roller among the two split rollers drops downward along the M2 first guide. In such a configuration, the drop position of the ink squeezed from the one split roller by the squeezing member can be controlled by the M1 first guide and the drop position of the ink squeezed from the other split roller by the squeezing member can be controlled by the M2 first guide.

M1 and M2 may be singular or plural. Therefore, The printer may be configured so that the M1 is not less than 2 and the M2 is not less than 2. Further, M1 and M2 may be the same as or different from each other.

The printer may further comprise: two cleaning solution suppliers, each configured to supply a cleaning solution to the ink absorbing roller, wherein one cleaning solution supplier among the two cleaning solution suppliers supplies a cleaning solution to the one split roller among the two split rollers, and the other cleaning solution supplier among the two cleaning solution suppliers supplies a cleaning solution to the other split roller among the two split rollers. In such a configuration, by the cleaning solution suppliers which are individually provided for the two split rollers, respectively, the cleaning solution can be accurately supplied to each split roller.

Further, in the printer in which the extending direction is inclined with respect to the horizontal direction, such a configuration is suitable. Specifically, in a case where the ink absorbing roller is not divided, when the extending direction of the ink absorbing roller is inclined, the cleaning solution unevenly pools in the end portion on the lower side of the ink absorbing roller. In contrast to this, when the ink absorbing roller includes two split rollers, it is possible to suppress the cleaning solution from unevenly pooling.

The printer may be configured so that a gap is provided between the two split rollers. In such a configuration, it is thereby possible to suppress the cleaning solution supplied to the upper split roller from going to the lower split roller and possible to suppress the cleaning solution from unevenly pooling.

The printer may be configured so that the squeezing member has M1 first guide protruding downward and M2 first guide protruding downward, M1 being an integer not less than 1, M2 being an integer not less than 1, ink squeezed by the squeezing member from the one split roller among the two split rollers drops downward along the M1 first guide together with a cleaning solution, and ink squeezed by the squeezing member from the other split roller among the two split rollers drops downward along the M2 first guide together with a cleaning solution. In such a configuration, it is possible to control the drop position of ink by guiding the ink by each first guide.

The printer may be configured so that the extending direction descends from one side toward the other side, at least one first guide among the M1 first guide is positioned on the one side relative to a center of the one split roller in the extending direction, and at least one first guide among the M2 first guide is positioned on the one side relative to a center of the other split roller in the extending direction. In such a configuration, it is possible to suppress the cleaning solution from unevenly pooling in the end portion on the lower side of each split roller.

The printer may further comprises: two ink receivers provided corresponding to the two split rollers, wherein ink squeezed by the squeezing member from the one split roller among the two split rollers drops along the M1 first guide together with a cleaning solution onto the one ink receiver among the two ink receivers, and ink squeezed by the squeezing member from the other split roller among the two split rollers drops along the M2 first guide together with a cleaning solution onto the other ink receiver among the two ink receivers. In such a configuration, it is possible to accurately drop ink onto the one ink receiver by the M1 first guides and accurately drop ink onto the other ink receiver by the M2 first guides.

The printer may be configured so that in a state where the moving mechanism brings the two split rollers into contact with an end portion of the squeezing member, the one cleaning solution supplier supplies a cleaning solution to drop the cleaning solution onto the one ink receiver from the M1 first guide while causing the one split roller to overlap the M1 first guide from above when viewed from above, and the other cleaning solution supplier supplies a cleaning solution to drop the cleaning solution onto the other ink receiver from the M2 first guide while causing the other split roller to overlap the M2 first guide from above when viewed from above. In such a configuration, the ink receiver can be cleaned with the cleaning solution, to thereby wash away the ink and the like stuck to the ink receiver.

Thus, according to the present disclosure, it becomes possible to squeeze ink from the ink absorbing roller which absorbs ink from the wiper while suppressing the ink absorbing roller from being worn out.

The above and further objects and novel features of the disclosure will more fully appear from the following detailed description when the same is read in connection with the accompanying drawing. It is to be expressly understood, however, that the drawing is for purpose of illustration only and is not intended as a definition of the limits of the disclosure.

Although the disclosure has been described with reference to specific embodiments, this description is not meant to be construed in a limiting sense. Various modifications of the disclosed embodiment, as well as other embodiments of the present disclosure, will become apparent to persons skilled in the art upon reference to the description of the disclosure. It is therefore contemplated that the appended claims will cover any such modifications or embodiments as fall within the true scope of the disclosure.

What is claimed is:

1. A printer, comprising:
an inkjet head having a nozzle opening plane having an opening from which ink is ejected;
a wiper contacting the nozzle opening plane of the inkjet head to wipe off ink from the nozzle opening plane;
an ink absorbing roller rotatably supported about a predetermined rotation axis;
a squeezing member; and
a moving mechanism configured to move the squeezing member relative to the ink absorbing roller in a moving direction orthogonal to the rotation axis,
wherein the ink absorbing roller contacts the wiper to absorb ink from the wiper, to thereby clean the wiper,
the moving mechanism moves the squeezing member relative to the ink absorbing roller in the moving direction while the squeezing member is in contact with the ink absorbing roller, to thereby causes the squeezing member to squeeze ink from the ink absorbing roller, and
the ink absorbing roller rotates, following the squeezing member which moves relatively in the moving direction.

2. The printer according to claim 1, wherein
the squeezing member has an inclined surface which is inclined with respect to the moving direction and the inclined surface of the squeezing member contacts the ink absorbing roller.

3. The printer according to claim 2, wherein
the squeezing member further has an upper surface extended in the moving direction, and
the inclined surface is so provided as to descend from an end of the upper surface in the moving direction.

4. The printer according to claim 3, wherein
the squeezing member further has a side surface extended downward from an end of the inclined surface which is opposite to the upper surface in the moving direction.

5. The printer according to claim 4, wherein
the squeezing member further has a first guide tapered downward from the side surface.

6. The printer according to claim 5, further comprising:
a collection tray receiving ink dropping from the first guide of the squeezing member.

7. The printer according to claim 5, wherein
a plurality of first guides is provided in an extending direction of the rotation axis.

8. The printer according to claim 1, wherein
the ink absorbing roller includes two split rollers disposed in an extending direction of the rotation axis.

9. The printer according to claim 8, further comprising:
two ink receivers provided corresponding to the two split rollers,
wherein ink squeezed by the squeezing member from one split roller among the two split rollers drops onto one ink receiver among the two ink receivers, and
ink squeezed by the squeezing member from the other split roller among the two split rollers drops onto the other ink receiver among the two ink receivers.

10. The printer according to claim 8, wherein
the squeezing member has M1 first guide protruding downward and M2 first guide protruding downward, M1 being an integer not less than 1, M2 being an integer not less than 1,
ink squeezed by the squeezing member from the one split roller among the two split rollers drops downward along the M1 first guide, and
ink squeezed by the squeezing member from the other split roller among the two split rollers drops downward along the M2 first guide.

11. The printer according to claim 10, wherein
the M1 is not less than 2 and the M2 is not less than 2.

12. The printer according to claim 8, further comprising:
two cleaning solution suppliers, each configured to supply a cleaning solution to the ink absorbing roller,
wherein one cleaning solution supplier among the two cleaning solution suppliers supplies a cleaning solution to the one split roller among the two split rollers, and
the other cleaning solution supplier among the two cleaning solution suppliers supplies a cleaning solution to the other split roller among the two split rollers.

13. The printer according to claim 12, wherein
the extending direction is inclined with respect to a horizontal direction.

14. The printer according to claim 13, wherein
a gap is provided between the two split rollers.

15. The printer according to claim 12, wherein
the squeezing member has M1 first guide protruding downward and M2 first guide protruding downward, M1 being an integer not less than 1, M2 being an integer not less than 1,
ink squeezed by the squeezing member from the one split roller among the two split rollers drops downward along the M1 first guide together with a cleaning solution, and
ink squeezed by the squeezing member from the other split roller among the two split rollers drops downward along the M2 first guide together with a cleaning solution.

16. The printer according to claim 15, wherein
the extending direction descends from one side toward the other side,
at least one first guide among the M1 first guide is positioned on the one side relative to a center of the one split roller in the extending direction, and
at least one first guide among the M2 first guide is positioned on the one side relative to a center of the other split roller in the extending direction.

17. The printer according to claim 16, further comprising:
two ink receivers provided corresponding to the two split rollers,
wherein ink squeezed by the squeezing member from the one split roller among the two split rollers drops along the M1 first guide together with a cleaning solution onto the one ink receiver among the two ink receivers, and
ink squeezed by the squeezing member from the other split roller among the two split rollers drops along the M2 first guide together with a cleaning solution onto the other ink receiver among the two ink receivers.

18. The printer according to claim 17, wherein
in a state where the moving mechanism brings the two split rollers into contact with an end portion of the squeezing member,
the one cleaning solution supplier supplies a cleaning solution to drop the cleaning solution onto the one ink receiver from the M1 first guide while causing the one split roller to overlap the M1 first guide from above when viewed from above, and
the other cleaning solution supplier supplies a cleaning solution to drop the cleaning solution onto the other ink receiver from the M2 first guide while causing the other split roller to overlap the M2 first guide from above when viewed from above.

19. The printer according to claim 4, further comprising:
a collection tray, and
the squeezing member further having a second guide guiding ink dropping from the side surface of the squeezing member to a collection position away from the wiper,
wherein the collection tray receives ink which is guided to the collection position.

20. The printer according to claim 4, wherein
the squeezing member further has a lower surface which is so extended in parallel to the upper surface in the moving direction as to face the upper surface from below and a recessed portion provided between a lower end of the side surface and the lower surface in the moving direction, and
the recessed portion is recessed upward from each of the lower end of the side surface, and the lower surface.

21. The printer according to claim 1, further comprising:
a wiper lifting and lowering mechanism configured to lift and lower the wiper,
wherein the wiper lifting and lowering mechanism is so disposed as to face the squeezing member from below.

22. The printer according to claim 21, further comprising:
a cover member disposed between the squeezing member and the wiper lifting and lowering mechanism in a vertical direction,
wherein the cover member overlaps at least part of the wiper lifting and lowering mechanism when viewed in a vertical direction.

23. The printer according to claim 22, further comprising:
a screw fastening the squeezing member and the cover member to each other; and
a seal washer into which the screw is inserted,
wherein the squeezing member has a counterbore in which the seal washer is disposed and an insertion hole provided for the counterbore,
the cover member has a screw hole facing the insertion hole,
the screw is screwed into the screw hole while being inserted into the seal washer and the insertion hole, and
the seal washer seals a gap between the insertion hole and the screw.

24. The printer according to claim 1, further comprising:
a collection tray receiving ink dropping from the squeezing member.

25. The printer according to claim 24, wherein
the collection tray receives ink dropping from the wiper.

26. A maintenance method of an ink absorbing roller which absorbs ink from a wiper wiping off ink from a nozzle opening plane of an inkjet head, comprising:
squeezing ink from the ink absorbing roller by a squeezing member, by moving the squeezing member relatively to the ink absorbing roller in a moving direction while the squeezing member is in contact with the ink absorbing roller,
wherein the ink absorbing roller rotates, following the squeezing member which moves relatively in the moving direction.
